(19) United States
(12) Patent Application Publication
(10) Pub. No.: US 2023/0319306 A1
(43) Pub. Date: Oct. 5, 2023

(54) IMAGE PROCESSING APPARATUS AND METHOD

(71) Applicant: SONY SEMICONDUCTOR SOLUTIONS CORPORATION, KANAGAWA (JP)

(72) Inventors: KASHU TAKAHASHI, KANAGAWA (JP); TAKASHI FUKUYAMA, KANAGAWA (JP)

(21) Appl. No.: 18/040,906

(22) PCT Filed: Aug. 13, 2021
(86) PCT No.: PCT/JP2021/029793

§ 371 Date: Feb. 7, 2023

(30) Foreign Application Priority Data
Aug. 27, 2020 (JP) 2020-143734

(51) Int. Cl. G06T 3/40; H04N 19/176; H04N 19/59; G06T 5/50

(52) U.S. Cl. CPC H04N 19/59; G06T 3/40; G06T 5/50; H04N 19/176; G06T 2207/20221

(57) ABSTRACT

The present disclosure relates to an image processing apparatus and an image processing method that can inhibit a decrease of coding efficiency.

A transfer image that is a to-be-transferred image with a normal size including a downsized image obtained by size-reduction of a normal image whose image size is the normal size to a reduced size that is an image size smaller than the normal size is generated, and the generated transfer image is coded. Coded data is decoded, a transfer image that is a to-be-transferred image with a normal size including a downsized image obtained by size-reduction of a normal image whose image size is the normal size to a reduced size that is an image size smaller than the normal size is generated, and the downsized image is extracted from the generated transfer image. For example, the present disclosure can be applied to an image processing apparatus, an image coding apparatus, an image decoding apparatus, a transmitting apparatus, a receiving apparatus, a transmitting/receiving apparatus, an information processing apparatus, an image-capturing apparatus, a reproducing apparatus, an image processing method, or the like.

### TECHNICAL FIELD

The present disclosure relates to an image processing apparatus and an image processing method, and in particular relates to an image processing apparatus and an image processing method that can inhibit a decrease of coding efficiency.

### BACKGROUND ART

There have been conventional methods proposed to code moving images (e.g., NPL 1). In recent years, for example, development of low-latency real-time image transfer systems that use such coding as an image transfer system that requires mutual responses on transmitting and receiving sides and an image transfer system used for on Air broadcasting is underway. One possible method conceived of to reduce the transfer data amount in such a system when a narrower transfer band is available is to code images with a resolution which is lowered according to the degree of the reduction of the transfer band.

### CITATION LIST

### Non Patent Literature

[NPL 1] Benjamin Bross, Jianle Chen, Shan Liu, “Versatile Video Coding (Draft 5),” JVET-N1001-v10, Joint Video Experts Team (JVET) of ITU-T SG 16 WP 3 and ISO/IEC JTC 1/SC 29/WG 11 14th Meeting: Geneva, CH, 19-27 Mar. 2019

### SUMMARY

### Technical Problem

However, in the case of this method, since a new encoding sequence starts if an image size is changed, there has been a risk of decreased coding efficiency.

The present disclosure has been made in view of such circumstances, and an object thereof is to make it possible to inhibit a decrease of coding efficiency.

### Solution to Problem

An image processing apparatus according to one aspect of the present technology is an image processing apparatus including a transfer image generating section that generates a transfer image that is a to-be-transferred image with a normal size including a downsized image obtained by size-reduction of a normal image whose image size is the normal size to a reduced size that is an image size smaller than the normal size, and a coding section that codes the transfer image generated by the transfer image generating section.

An image processing method according to the one aspect of the present technology is an image processing method including generating a transfer image that is a to-be-transferred image with a normal size including a downsized image obtained by size-reduction of a normal image whose image size is the normal size to a reduced size that is an image size smaller than the normal size, and coding the generated transfer image.

An image processing apparatus according to another aspect of the present technology is an image processing apparatus including a decoding section that decodes coded data and generates a transfer image that is a to-be-transferred image with a normal size including a downsized image obtained by size-reduction of a normal image whose image size is the normal size to a reduced size that is an image size smaller than the normal size, and a downsized-image extracting section that extracts the downsized image from the transfer image generated by the decoding section.

An image processing method according to the other aspect of the present technology is an image processing method including decoding coded data and generating a transfer image that is a to-be-transferred image with a normal size including a downsized image obtained by size-reduction of a normal image whose image size is the normal size to a reduced size that is an image size smaller than the normal size, and extracting the downsized image from the generated transfer image.

In the image processing apparatus and the image processing method according to the one aspect of the present technology, a transfer image that is a to-be-transferred image with a normal size including a downsized image obtained by size-reduction of a normal image whose image size is the normal size to a reduced size that is an image size smaller than the normal size is generated, and the generated transfer image is coded.

In the image processing apparatus and the image processing method according to the other aspect of the present technology, coded data is decoded, a transfer image that is a to-be-transferred image with a normal size including a downsized image obtained by size-reduction of a normal image whose image size is the normal size to a reduced size that is an image size smaller than the normal size is generated, and the downsized image is extracted from the generated transfer image.

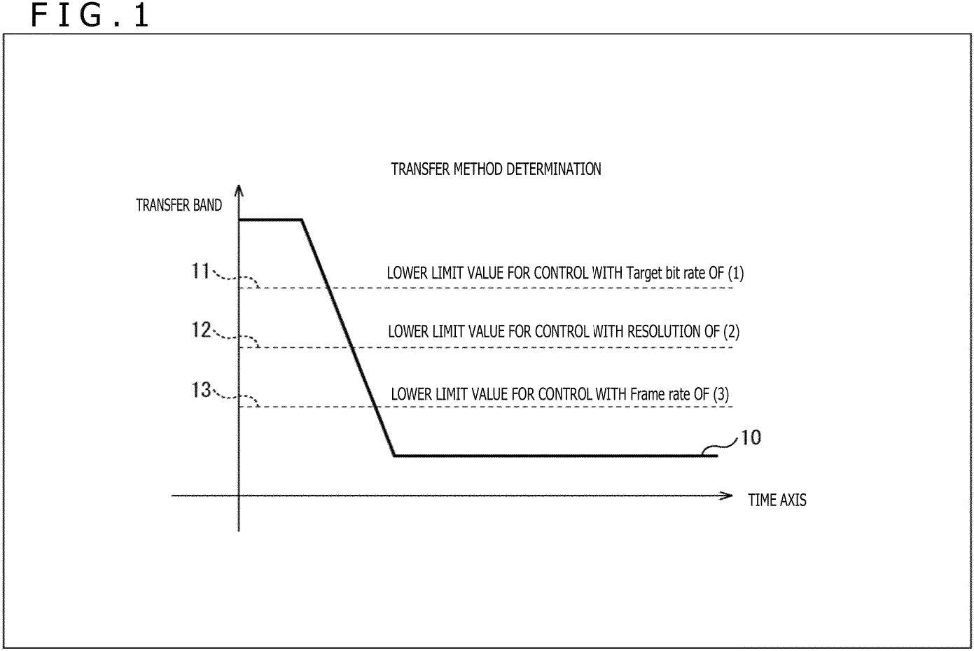

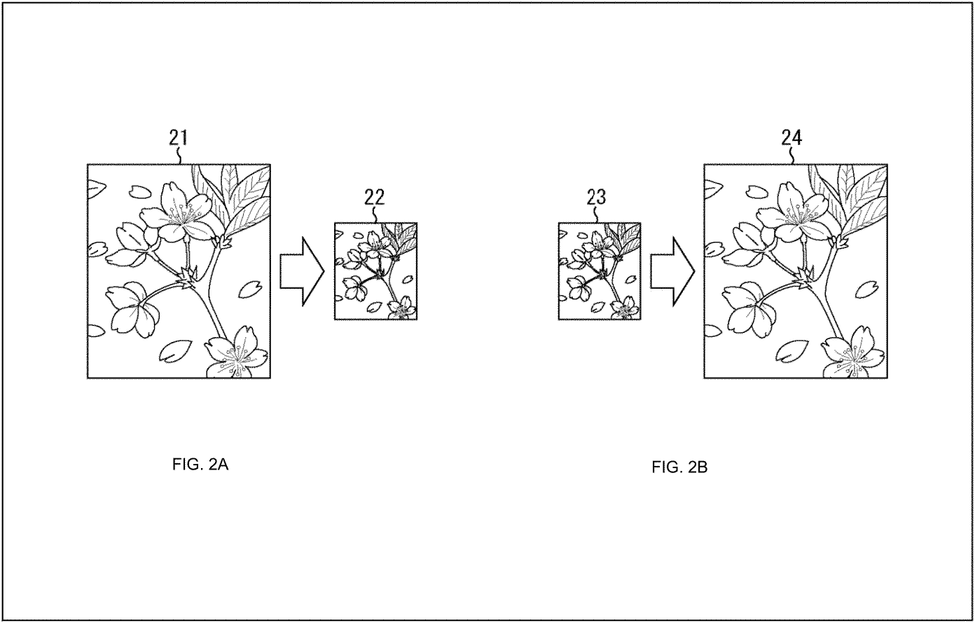

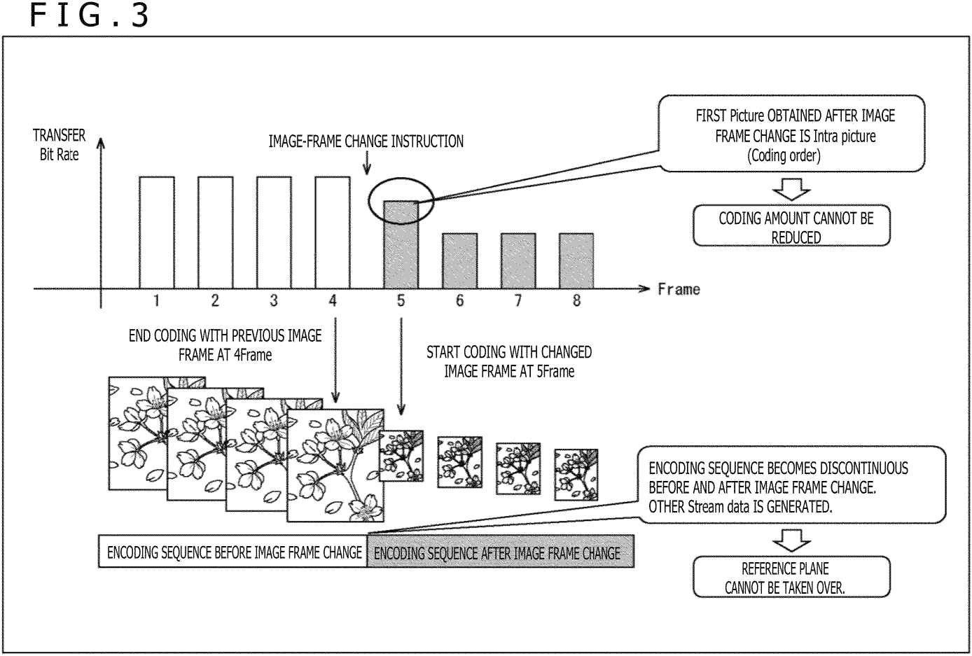

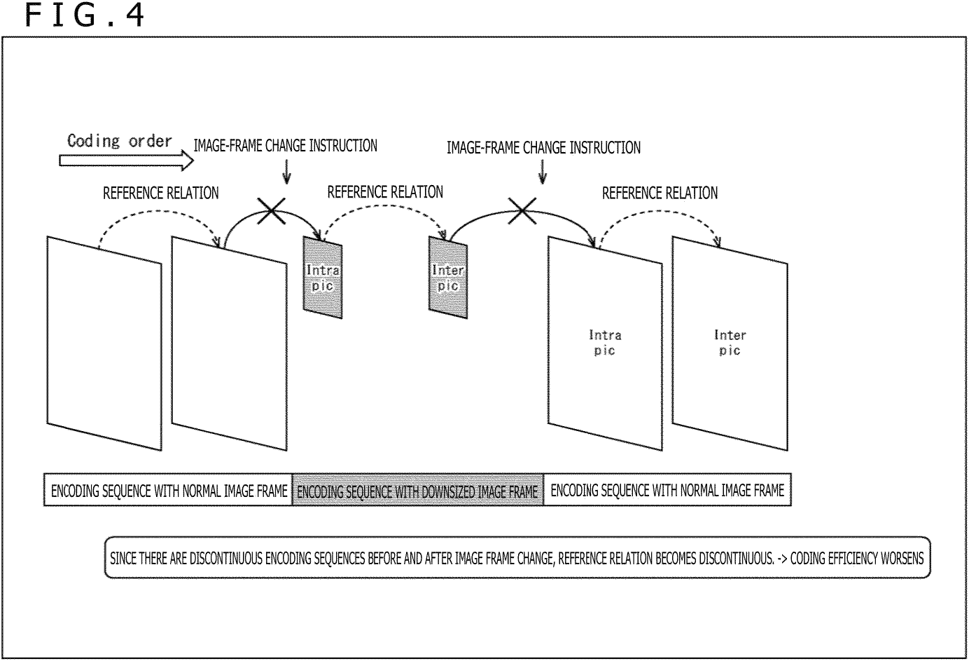

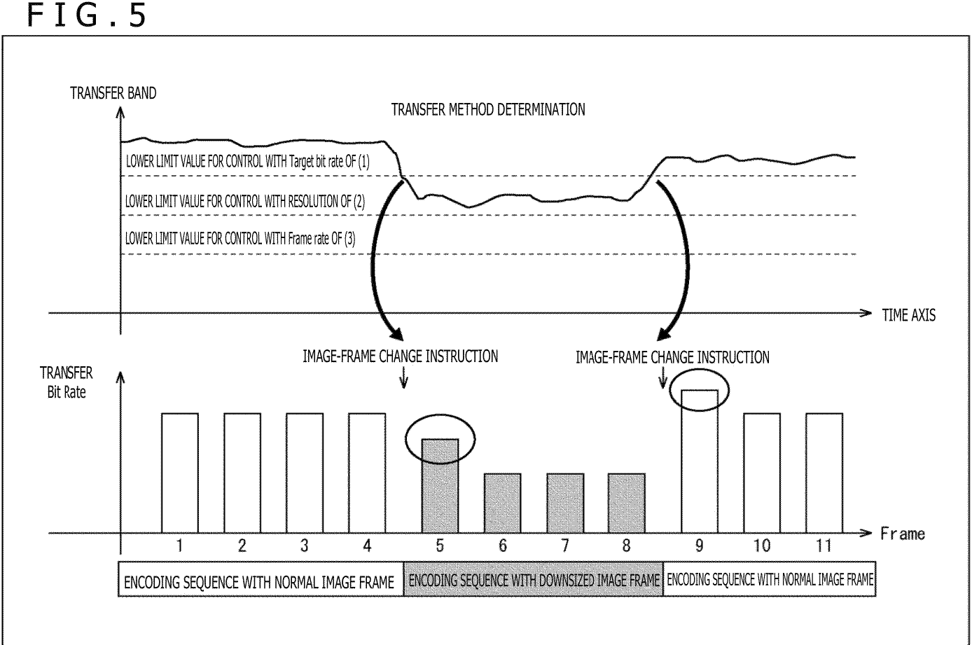

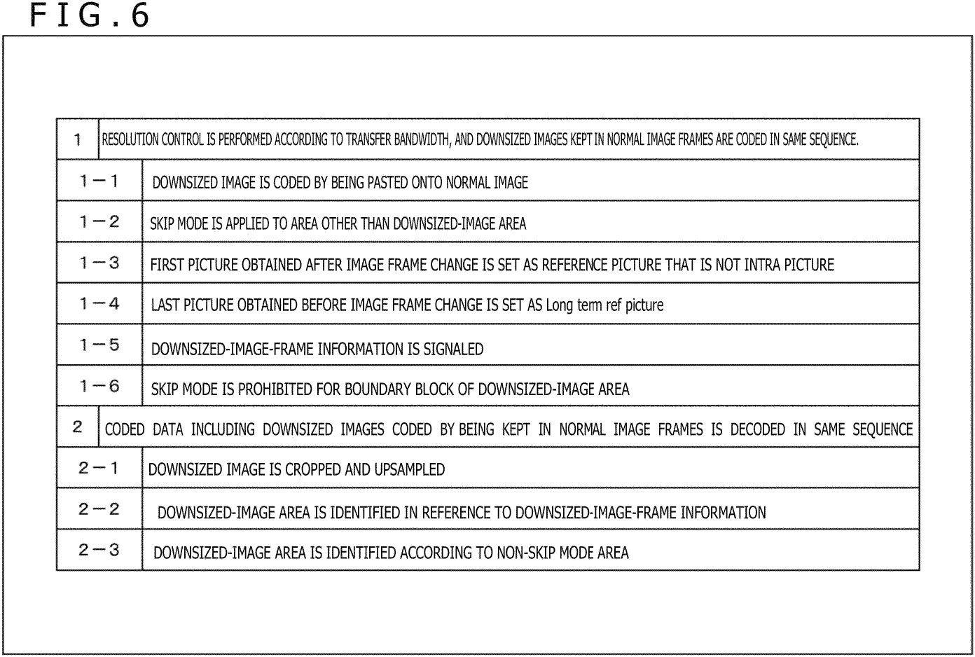

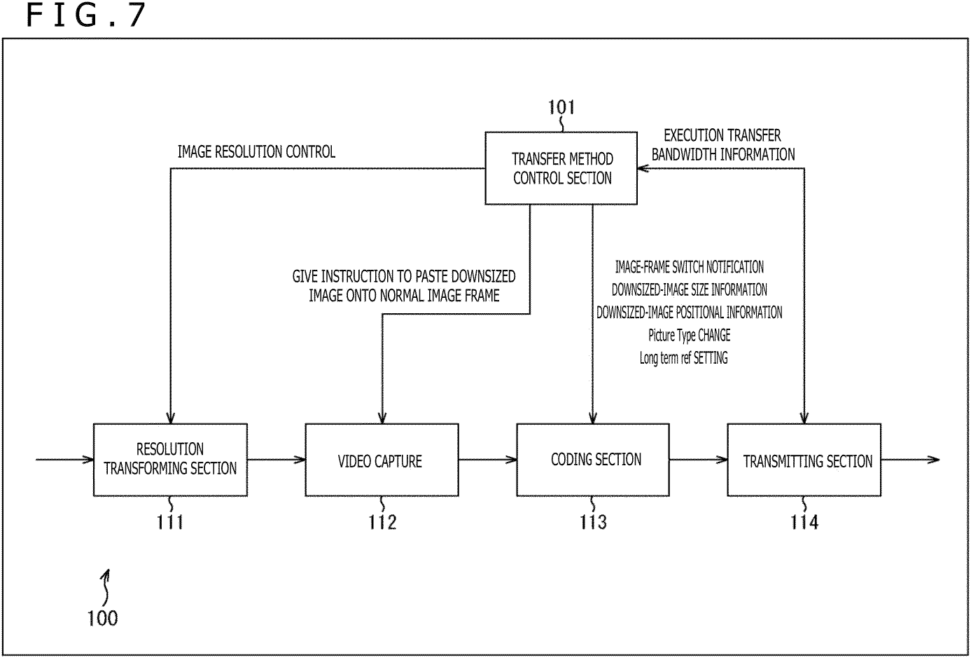

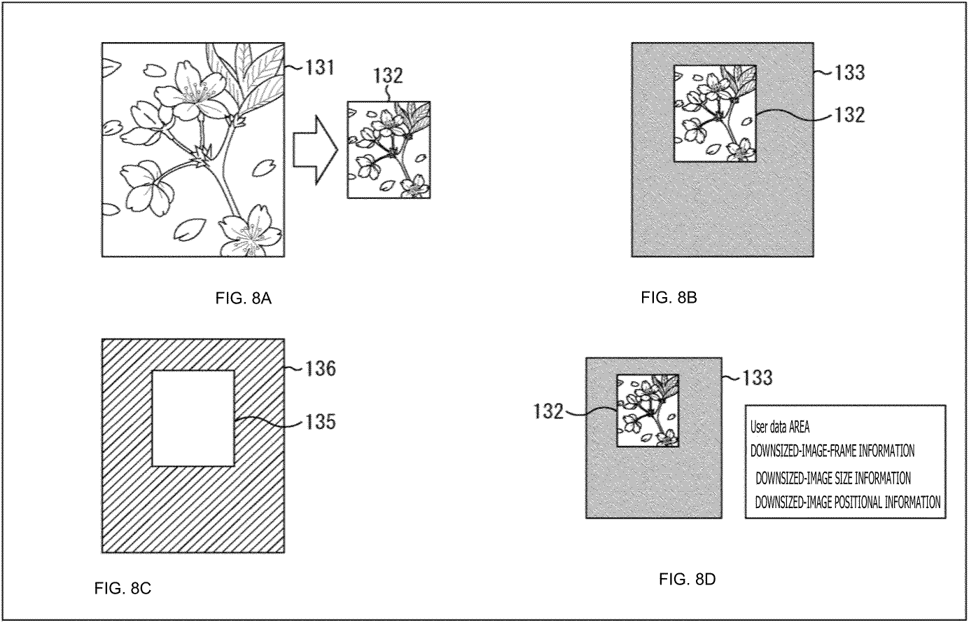

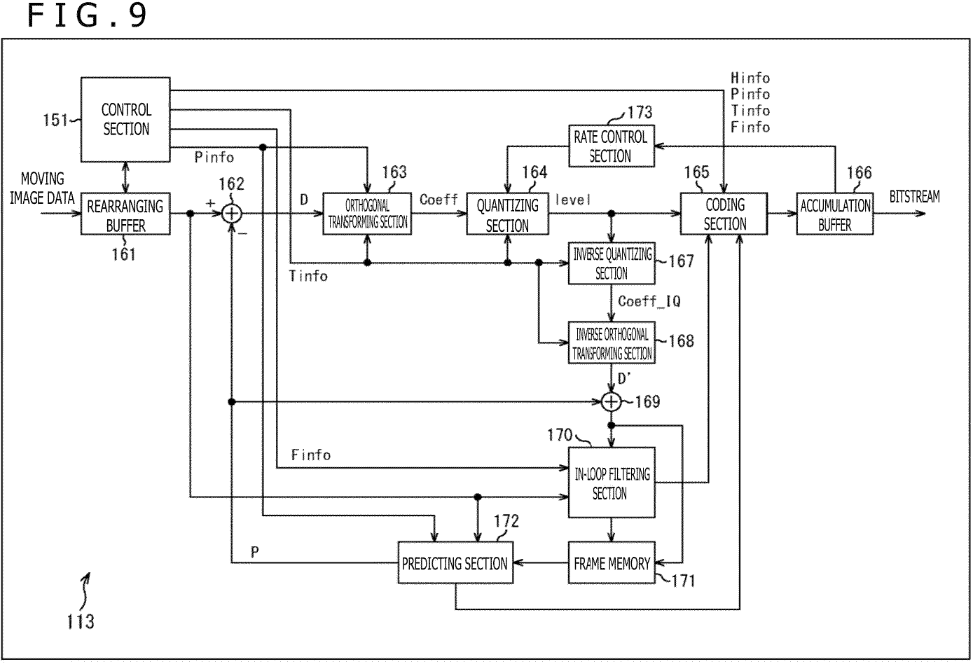

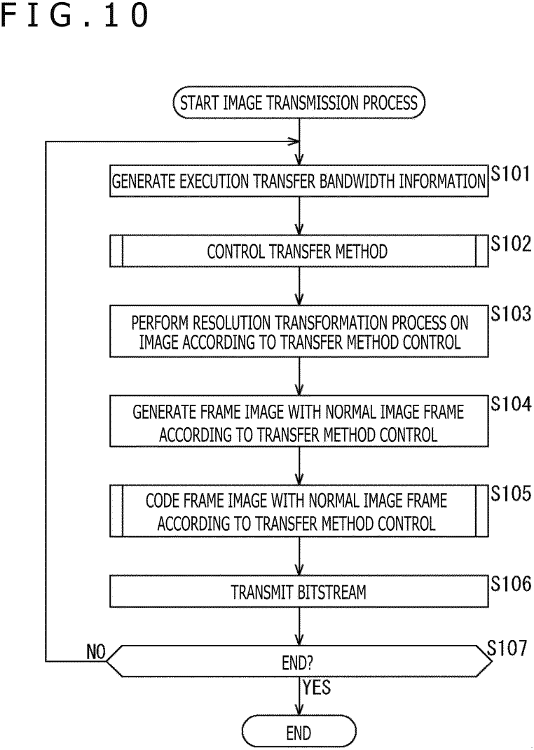

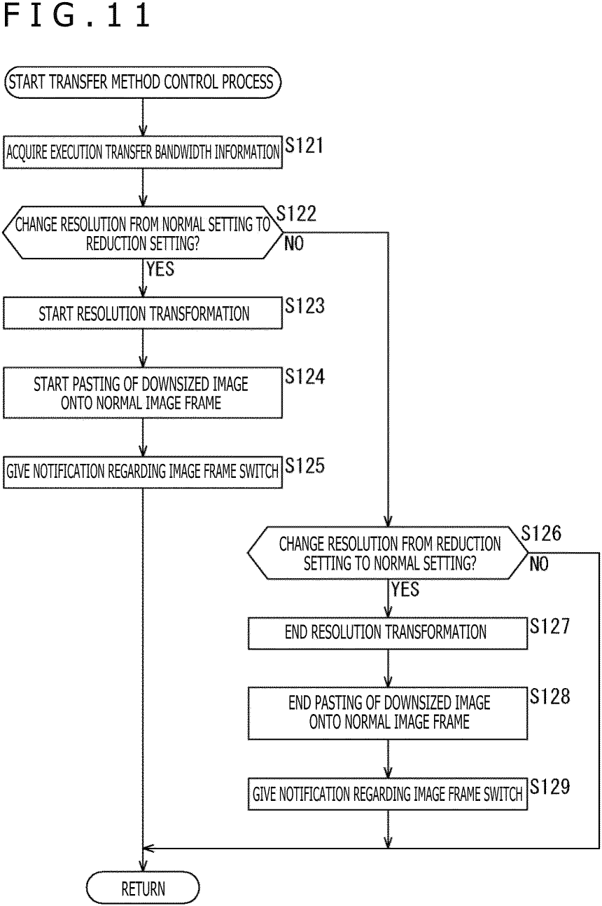

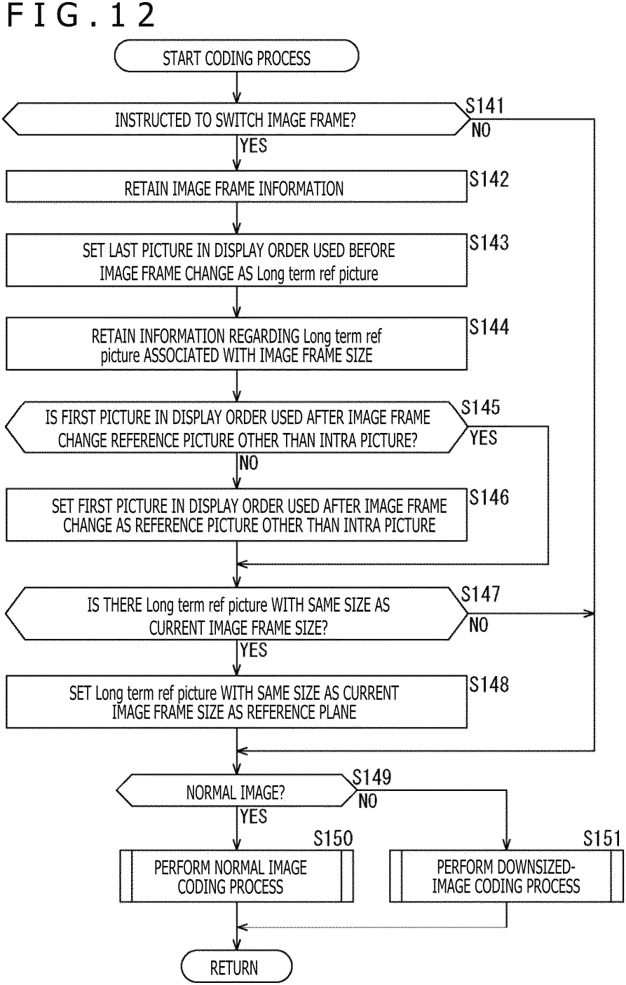

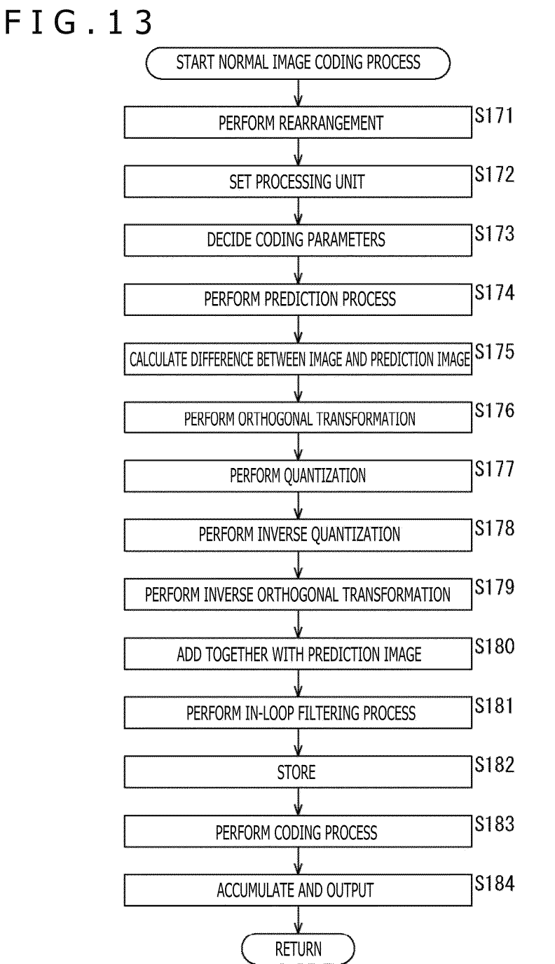

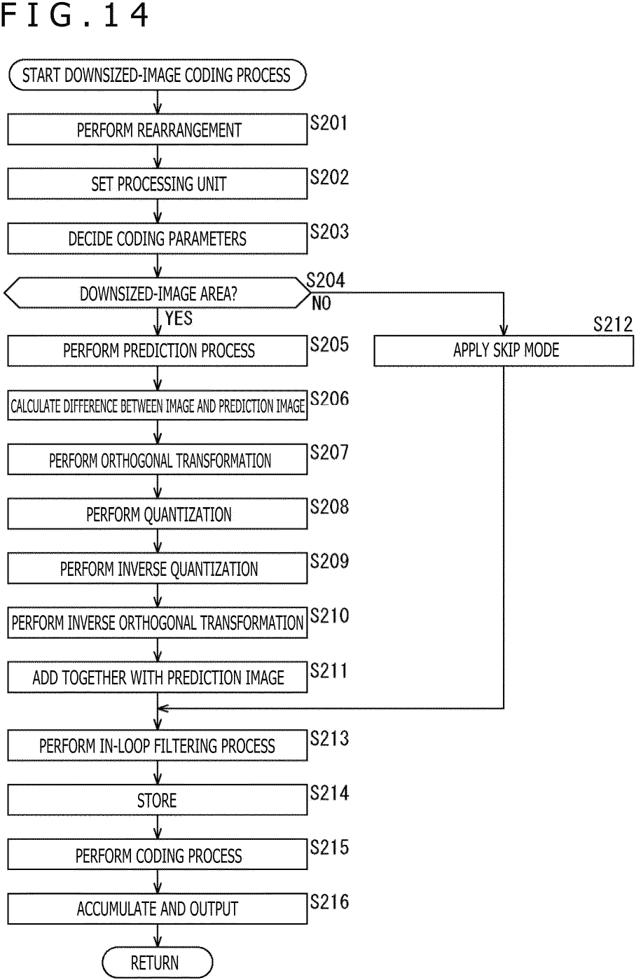

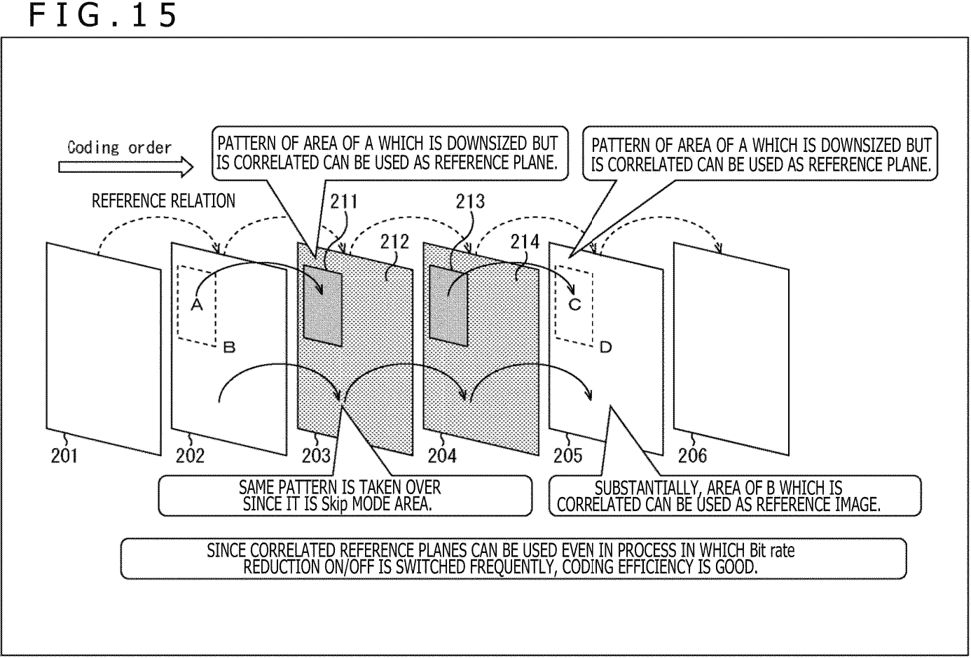

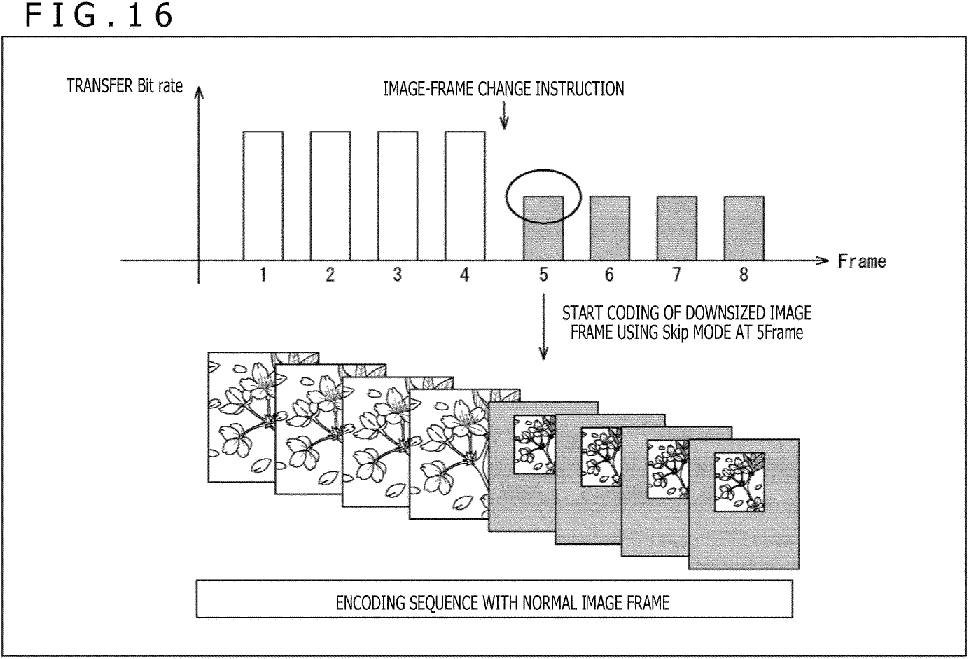

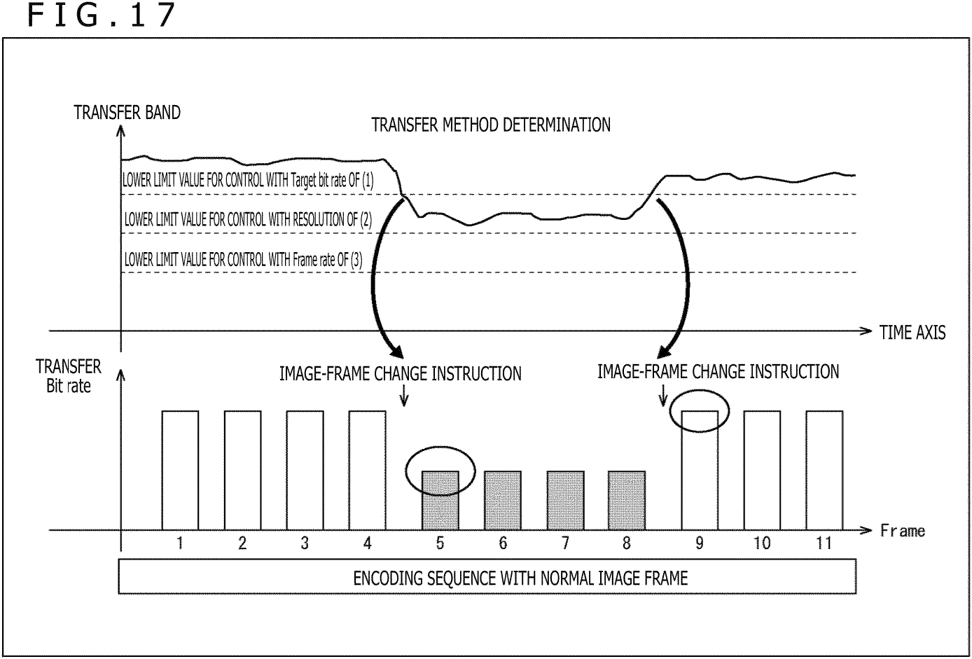

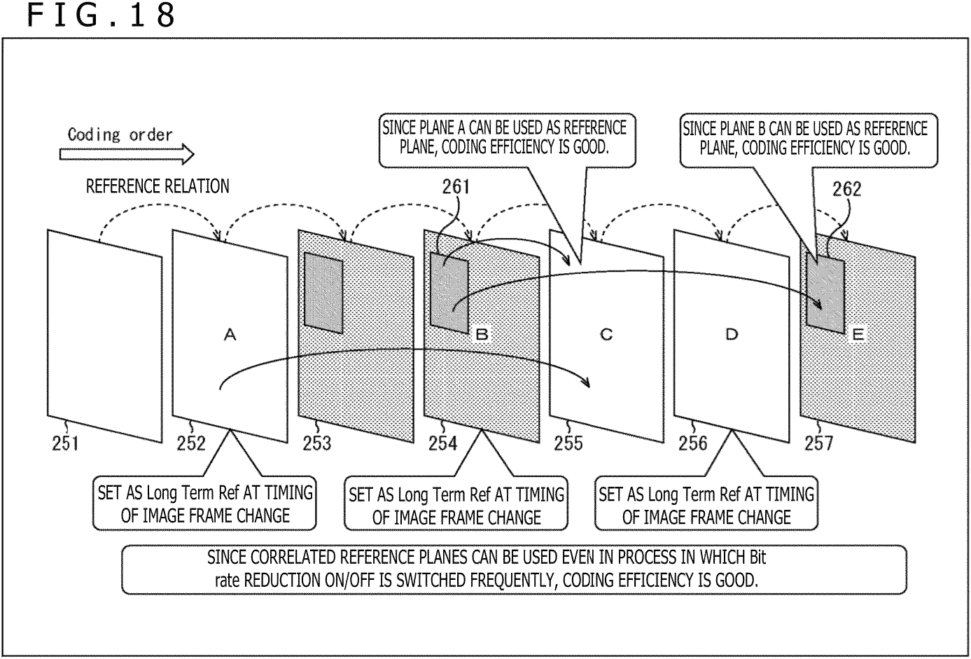

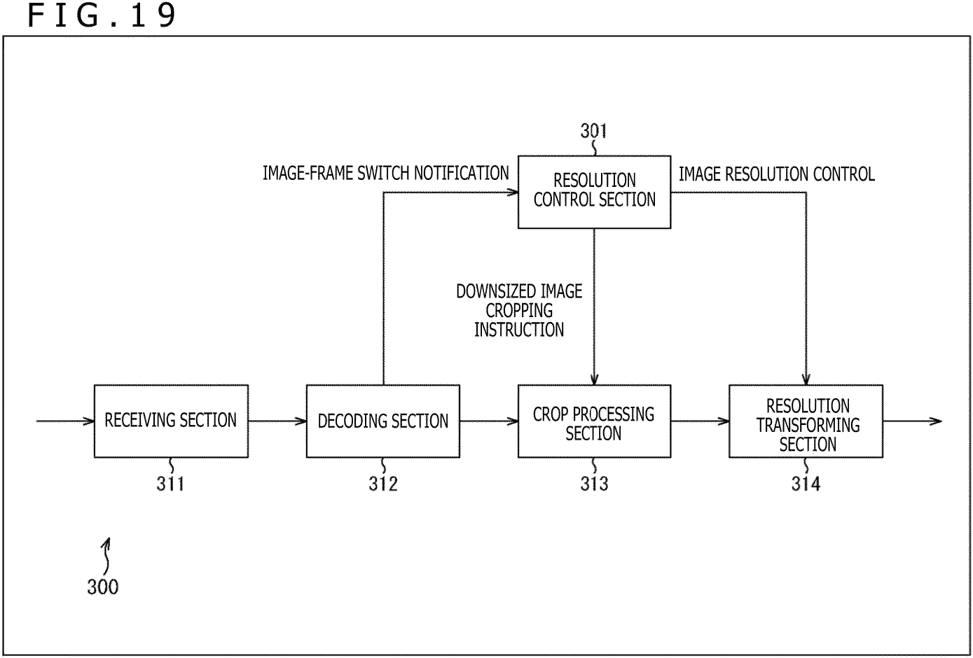

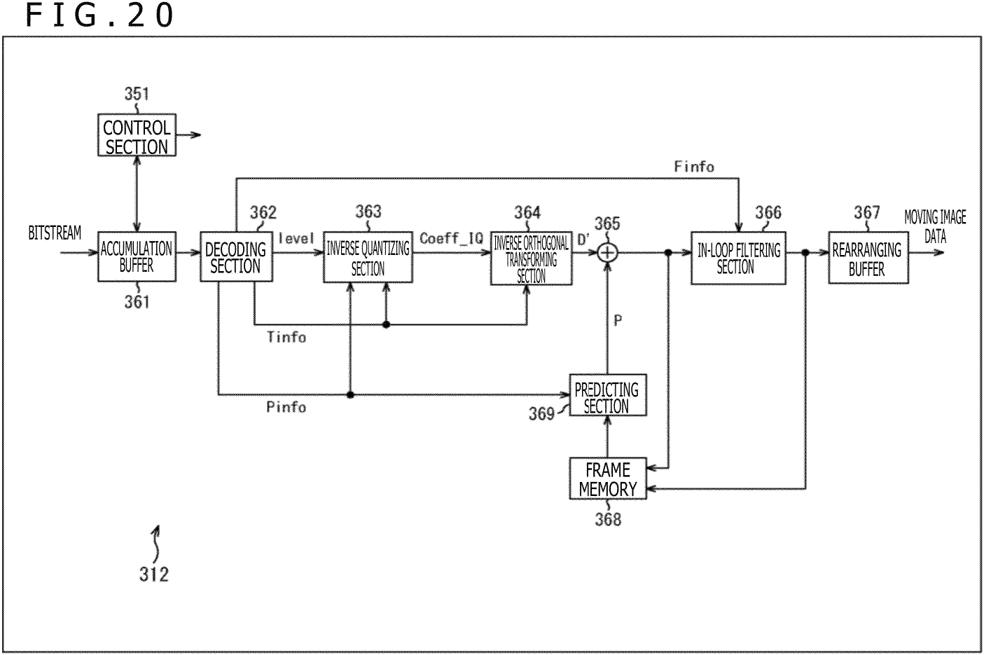

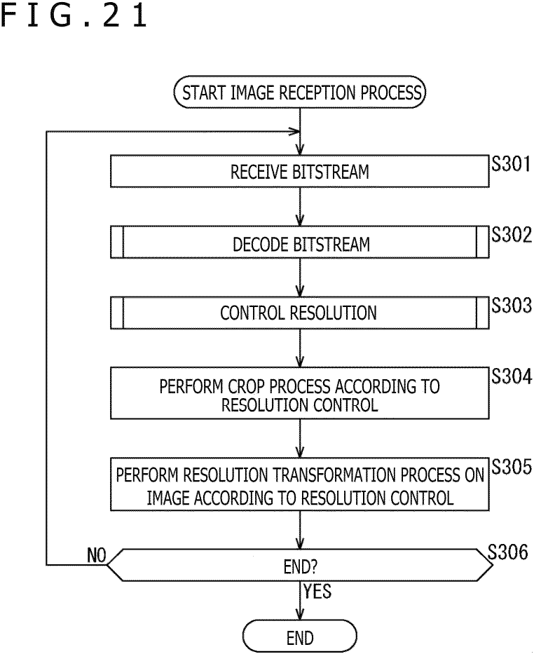

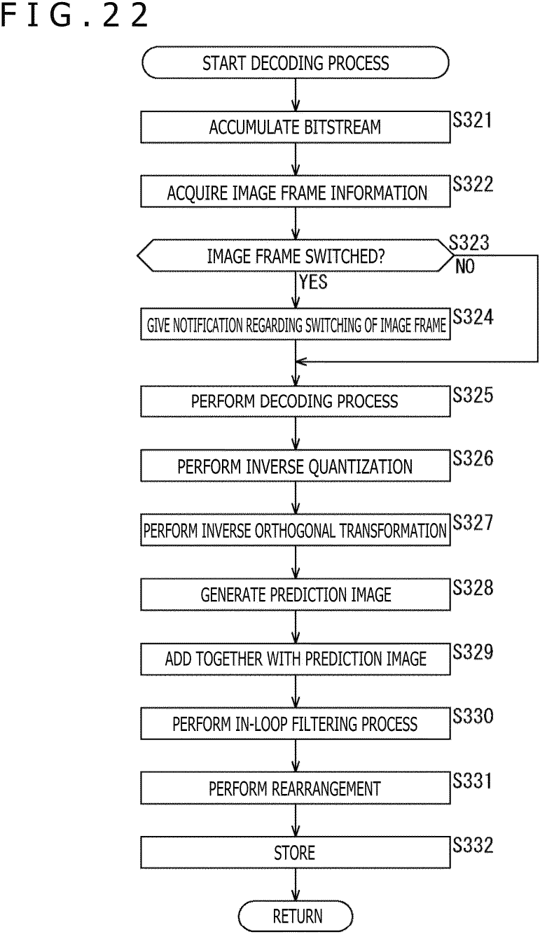

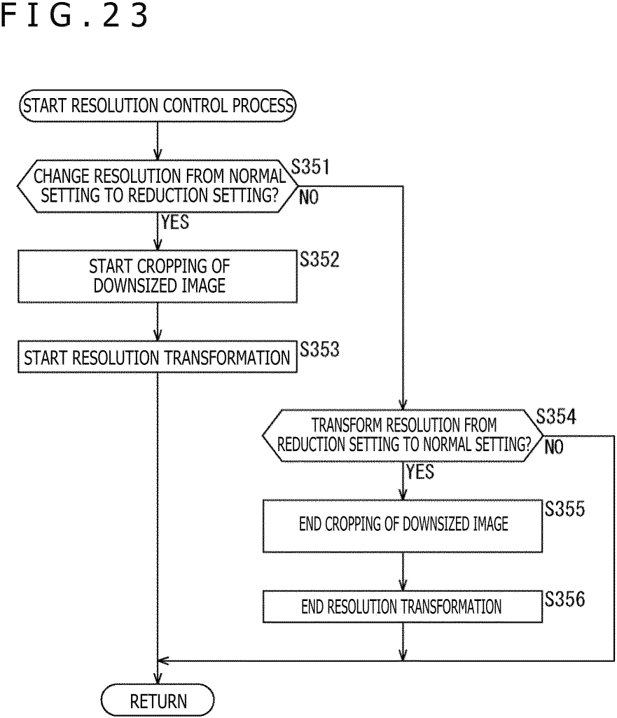

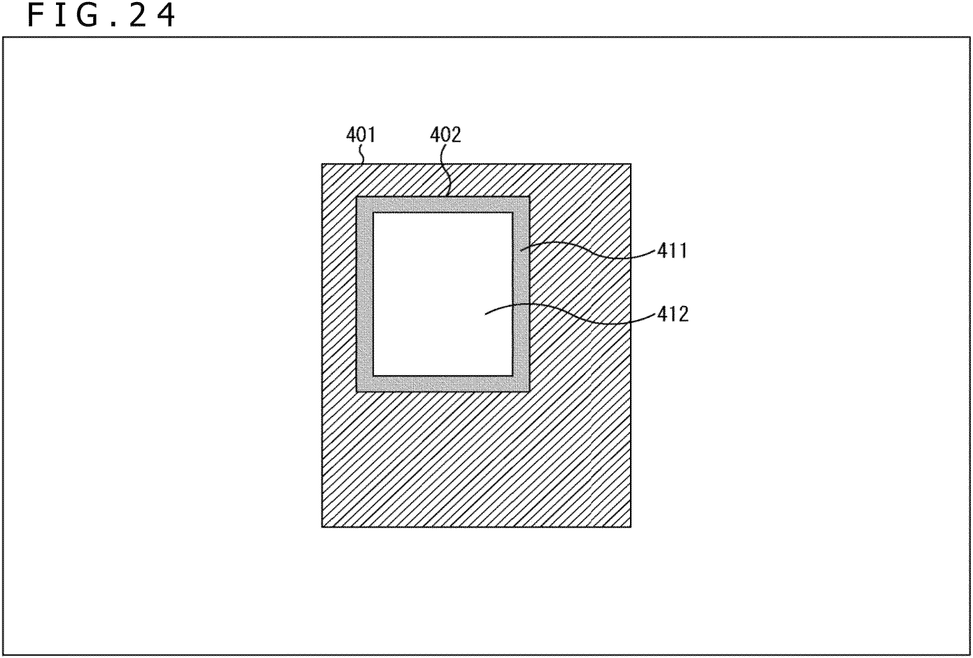

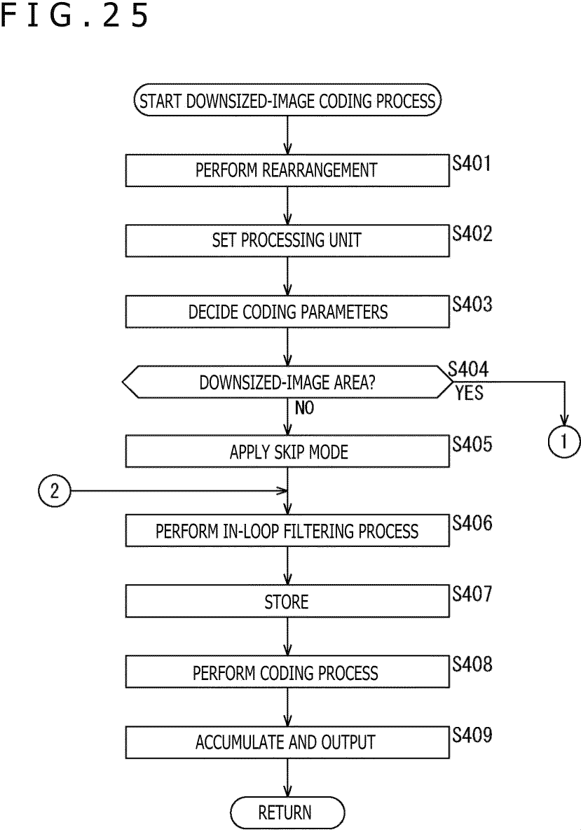

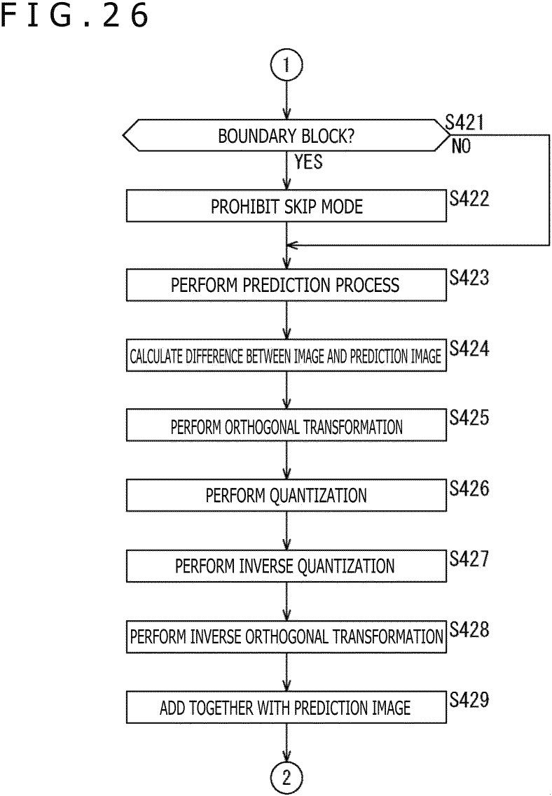

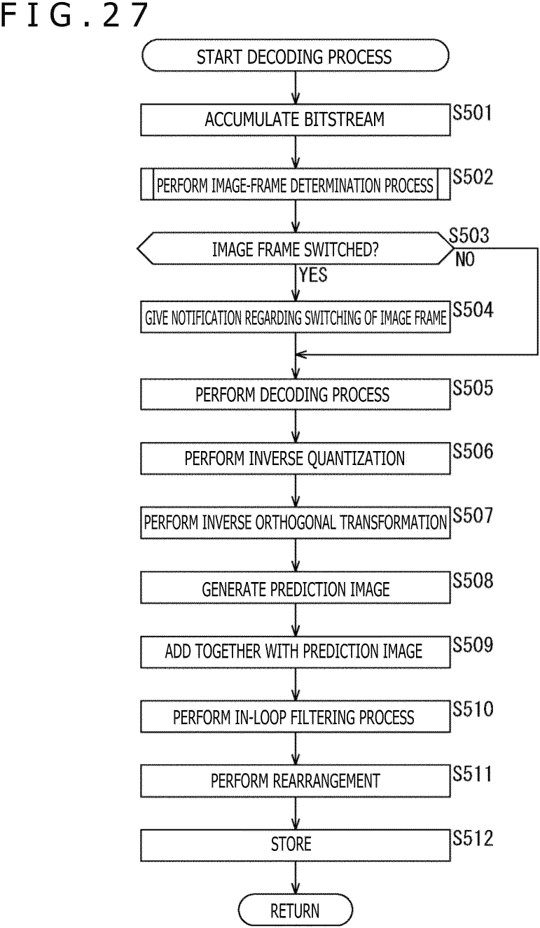

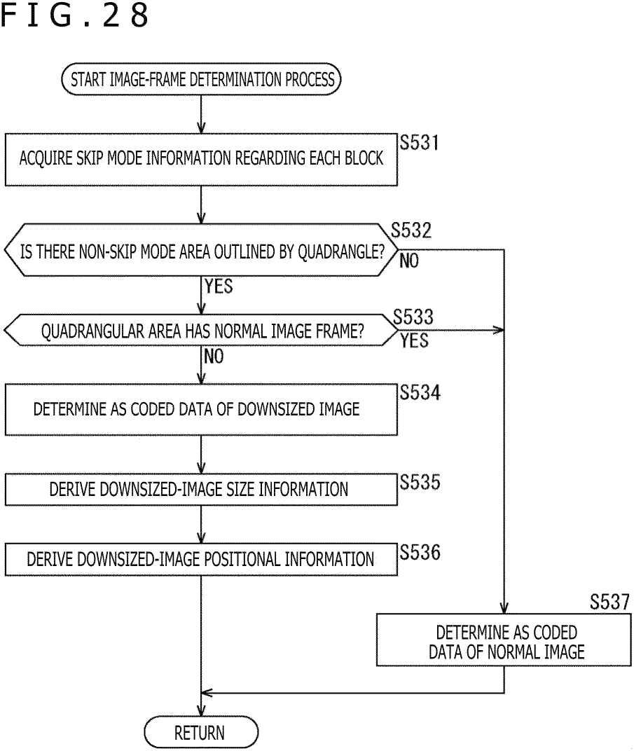

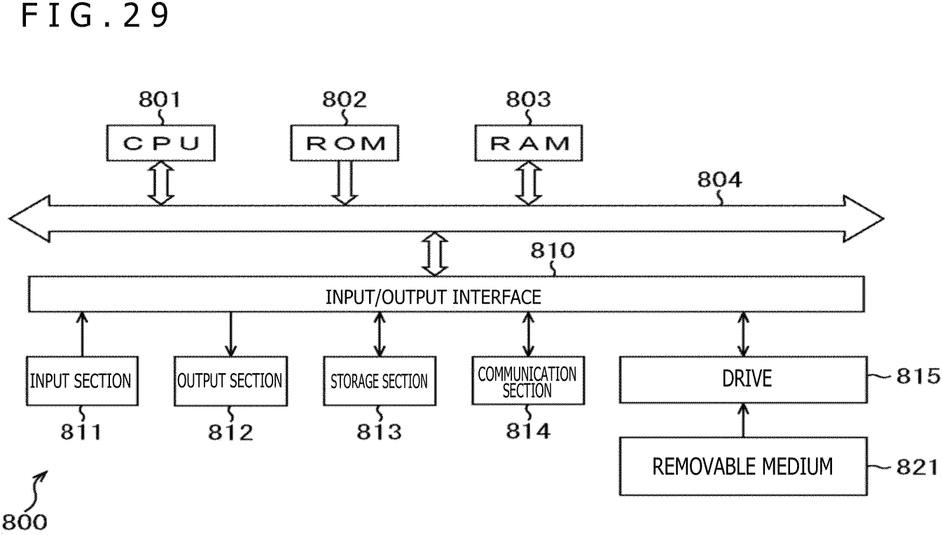

### BRIEF DESCRIPTION OF DRAWINGS

[FIG. 1] FIG. 1 is a figure for explaining a transfer determination method.

[FIG. 2] FIG. 2 depicts figures for explaining an example of resolution control.

[FIG. 3] FIG. 3 is a figure for explaining an example of resolution control.

[FIG. 4] FIG. 4 is a figure for explaining an example of resolution control.

[FIG. 5] FIG. 5 is a figure for explaining an example of resolution control.

[FIG. 6] FIG. 6 is a figure for explaining a resolution control method.

[FIG. 7] FIG. 7 is a block diagram depicting an example of a main configuration of an image transmitting apparatus.

[FIG. 8] FIG. 8 depicts figures for explaining a transfer image.

[FIG. 9] FIG. 9 is a block diagram depicting an example of a main configuration of a coding section.

[FIG. 10] FIG. 10 is a flowchart depicting an example of the procedure of an image transmission process.

[FIG. 11] FIG. 11 is a flowchart depicting an example of the procedure of a transfer method control process.

[FIG. 12] FIG. 12 is a flowchart for explaining an example of the procedure of a coding process.

[FIG. 13] FIG. 13 is a flowchart for explaining an example of the procedure of a normal image coding process.

[FIG. 14] FIG. 14 is a flowchart for explaining an example of the procedure of a downsized-image coding process.

[FIG. 15] FIG. 15 is a figure for explaining an example of resolution control.

[FIG. 16] FIG. 16 is a figure for explaining an example of resolution control.

[FIG. 17] FIG. 17 is a figure for explaining an example of resolution control.

[FIG. 18] FIG. 18 is a figure for explaining an example of resolution control.

[FIG. 19] FIG. 19 is a block diagram depicting an example of a main configuration of an image receiving apparatus.

[FIG. 20] FIG. 20 is a block diagram depicting an example of a main configuration of a decoding section.

[FIG. 21] FIG. 21 is a flowchart depicting an example of the procedure of an image reception process.

[FIG. 22] FIG. 22 is a flowchart depicting an example of the procedure of a decoding process.

[FIG. 23] FIG. 23 is a flowchart depicting an example of the procedure of a resolution control process.

[FIG. 24] FIG. 24 is a figure for explaining a transfer image.

[FIG. 25] FIG. 25 is a flowchart for explaining an example of the procedure of a downsized-image coding process.

[FIG. 26] FIG. 26 is a flowchart continuing from FIG. 25 for explaining an example of the procedure of the downsized-image coding process.

[FIG. 27] FIG. 27 is a flowchart depicting an example of the procedure of a decoding process.

[FIG. 28] FIG. 28 is a flowchart depicting an example of the procedure of an image determination process.

[FIG. 29] FIG. 29 is a block diagram depicting an example of a main configuration of a computer.

### DESCRIPTION OF EMBODIMENTS

Modes for carrying out the present disclosure (called embodiments below) are explained below. Note that explanations are given in the following order.
1. Documents, Etc., Supporting Technical Content/Technical Terms
2. Downsized-Image Transfer 1 with Normal Image Frame
3. First Embodiment (Image Transmitting Apparatus)
4. Second Embodiment (Image Receiving Apparatus)
5. Downsized-Image Transfer 2 with Normal Image Frame
6. Third Embodiment (Image Transmitting Apparatus)
7. Fourth Embodiment (Image Receiving Apparatus)
8. Notes

### 1. Documents, Etc., Supporting Technical Content/Technical Terms

The scope of disclosure of the present technology covers not only the content described in embodiments, but also the content described in the following pieces of NPL that are known at the time of the application.

NPL 1: (mentioned above)
NPL 2: Recommendation ITU-T H.264 (04/2017) “Advanced video coding for generic audiovisual services,” April 2017
NPL 3: Recommendation ITU-T H.265 (12/2016) “High efficiency video coding,” December 2016
NPL 4: J. Chen, E. Alshina, G. J. Sullivan, J.-R. Ohm, J. Boyce, “Algorithm Description of Joint Exploration Test Model (JEM7),” JVET-G1001, Joint Video Exploration Team (JVET) of ITU-T SG 16 WP 3 and ISO/IEC JTC 1/SC 29/WG 11 7th Meeting: Torino, IT, 13-21 Jul. 2017
NPL 5: B. Bross, J. Chen, S. Liu, “Versatile Video Coding (Draft 3),” JVET-L1001, Joint Video Experts Team (JVET) of ITU-T SG 16 WP 3 and ISO/IEC JTC 1/SC 29/WG 11 12th Meeting: Macau, CN, 3-12 Oct. 2018
NPL 6: J. J. Chen, Y. Ye, S. Kim, “Algorithm description for Versatile Video Coding and Test Model 3 (VTM 3),” JVET-L1002, Joint Video Experts Team (JVET) of ITU-T SG 16 WP 3 and ISO/IEC JTC 1/SC 29/WG 11 12th Meeting: Macau, CN, 3-12 Oct. 2018
NPL 7: Jianle Chen, Yan Ye, Seung Hwan Kim, “Algorithm description for Versatile Video Coding and Test Model 5 (VTM 5),” JVET-N1002-v2, Joint Video Experts Team (JVET) of ITU-T SG 16 WP 3 and ISO/IEC JTC 1/SC 29/WG 11 14th Meeting: Geneva, CH, 19-27 Mar. 2019

That is, the content described in the pieces of NPL mentioned above also serves as grounds for making a determination as to whether or not the support requirement is satisfied. For example, even in a case where, in embodiments, there are no direct descriptions regarding Quad-Tree Block Structure or QTBT (Quad Tree Plus Binary Tree) Block Structure described in the pieces of NPL mentioned above, they are covered by the scope of disclosure of the present technology, and the support requirement of claims is deemed to be satisfied. In addition, the same is true also for technical terms such as parse (Parsing), syntax (Syntax), or semantics (Semantics), for example, and even in a case where there are no direct descriptions regarding them in embodiments, they are covered by the scope of disclosure of the present technology, and the support requirement of claims is deemed to be satisfied.

In addition, unless noted otherwise, in the present specification, “blocks” (not blocks representing processing sections) used for explanations of partial areas and processing units of an image (picture) represent any partial areas in the picture, and the sizes, shapes, characteristics, and the like of those partial areas are not limited to any kind. For example, “blocks” include any partial areas (processing units) such as TB (Transform Block), TU (Transform Unit), PB (Prediction Block), PU (Prediction Unit), SCU (Smallest Coding Unit), CU (Coding Unit), LCU (Largest Coding Unit), CTB (Coding Tree Block), CTU (Coding Tree Unit), transformation block, subblock, macroblock, tile, or slice described in the pieces of NPL mentioned above.

In addition, when the size of such a block is to be specified, the block size may be specified not only directly, but also indirectly. For example, the block size may be specified with use of identification information identifying the size. In addition, for example, the block size may be specified with use of a ratio to or a difference from the size of a reference block (e.g., an LCU, an SCU, etc.). For example, in a case where information specifying the block size is transferred as a syntax element or the like, as the information, information indirectly specifying the size as the one mentioned above may be used. By doing so, the information amount of the information can be reduced, and coding efficiency can be enhanced, in some cases. In addition, the specification of the block size also includes specification of a range of block sizes (e.g., specification of a range of tolerated block sizes, etc.).

In addition, in the present specification, coding includes not only the entire process of transforming images into a bitstream, but also partial processes. For example, coding includes not only a process incorporating a prediction process, an orthogonal transformation, quantization, arithmetic coding, and the like, but also a process by which quantization and arithmetic coding are collectively referred to, a process incorporating a prediction process, quantization, and arithmetic coding, and the like. Similarly, decoding includes not only the entire process of transforming a bitstream into an image, but also partial processes. For example, decoding includes not only a process incorporating inverse arithmetic decoding, inverse quantization, an inverse orthogonal transformation, a prediction process, and the like, but also a process incorporating inverse arithmetic decoding and inverse quantization, a process incorporating inverse arithmetic decoding, inverse quantization, and a prediction process, and the like.

### 2. Downsized-Image Transfer 1 With Normal Image Frame

### <Transfer Method Determination>

As described in NPL 1, there has been a conventional method proposed to code moving images. In recent years, for example, development of low-latency real-time image transfer systems that use such coding as an image transfer system that requires mutual responses on transmitting and receiving sides and an image transfer system used for on Air broadcasting is underway. One possible method conceived of to reduce the transfer data amount in such a system when a narrower transfer band is available is to perform the following process according to the degree of the reduction of the transfer band as represented by a curve 10 in a graph in FIG. 1, for example.

1. In the initial phase (the transfer band at or above a dotted line 11 in FIG. 1) where the band has started becoming narrower, the target bitrate of coding is changed to a lower rate to thereby reduce the transfer data amount and make it equal to or lower than the transfer band.

2. In a case where the band has become too narrow to handle the situation by “1.” mentioned above (in a case of the transfer band at or above a dotted line 12 but below the dotted line 11 in FIG. 1), images are coded with a lower resolution to thereby reduce the transfer data amount and make it equal to or lower than the transfer band. On the receiving side, decoded images are upsampled to the original resolution at which the decoded images should be transmitted, and the decoded images are output-displayed.

3. In a case where the band has become too narrow to handle the situation by “2.” mentioned above (a case of the transfer band at or above a dotted line 13 but below the dotted line 12 in FIG. 1), the frame rate of images is reduced by insertion of picture skips (Picture Skips) and the like to thereby reduce the transfer data amount and make it equal to or lower than the transfer band. On the receiving side, images that are decoded such that the original frame rate at which the images should be transferred is attained are output and displayed again.

In a case where the resolution is changed as in “2.” mentioned above, for example, as depicted in A of FIG. 2, an image 21 is downsampled before coding, and a downsized image 22 is generated therefrom. A coder ends a coding process performed before an image frame change and performs a coding process according to a downsized image frame such that no gaps are created. A decoder performs a decoding process and generates a downsized image 23 (B of FIG. 2) from a bitstream. After the decoding, as depicted in B of FIG. 2, the downsized image 23 is upsampled to generate an image 24 with an image size which is the same as that of the original image 21.

That is, there are discontinuous encoding sequences as depicted in FIG. 3 before and after such an image frame change, and the coding process is ended and resumed (i.e., another stream is generated). Since a reference plane cannot be taken over at the discontinuous point of such sequences, as depicted in FIG. 4, coding needs to be started with an intra picture after the image frame change.

That is, in a state where the transfer data amount is desired to be reduced, coding of an intra picture with a large coding amount is performed as represented by the fifth frame depicted in FIG. 3, for example. Accordingly, there has been a risk of decreased coding efficiency. Stated differently, it has been necessary to further lower the image quality in order to further reduce the coding amount.

Additionally, as depicted in FIG. 4, another sequence (another stream) is generated every time an image frame (image size) is changed, and the reference relation becomes discontinuous (a reference plane is not taken over). Accordingly, there has been a risk that, as depicted in FIG. 5, at each of such instances, the coding amount increases, and further, coding efficiency decreases. Deterioration of coding efficiency due to such a fact that a reference plane is not taken over causes significant fluctuations of the transfer band, and becomes more noticeable in an environment where image frame changes are repeated.

### <Transfer in the Same Sequence>

In view of this, as written in the first row (top row) from top in a table in FIG. 6, resolution control is performed according to the transfer bandwidth, and downsized images kept in normal image frames are coded in the same sequence (method 1).

For example, a transfer image that is a to-be-transferred image with a normal size including a downsized image obtained by size-reduction of a normal image whose image size is the normal size to a reduced size that is an image size smaller than the normal size is generated, and the generated transfer image is coded.

For example, an image processing apparatus includes a transfer image generating section that generates a transfer image that is a to-be-transferred image with a normal size including a downsized image obtained by size-reduction of a normal image whose image size is the normal size to a reduced size that is an image size smaller than the normal size, and a coding section that codes the transfer image generated by the transfer image generating section.

Here, the normal size is the original image size of a transfer-subject image, and is the maximum image size at a time of resolution control. The normal image means a transfer-subject image with the normal size. In addition, the downsized image is an image with a size reduced from the size of the normal image by resolution control. The reduced size is the size of the downsized image. By such resolution control, the image size of a transfer-subject image is variable (can be reduced from the normal size), but the image size of a transfer image to be actually coded is fixed at the normal size.

By doing so, an image size can be changed without causing a discontinuity of a sequence, and it becomes possible to take over a reference plane before and after an image frame change; therefore, a decrease of coding efficiency due to resolution control can be inhibited.

The transfer image may be any image as long as it has the normal size and additionally includes a downsized image. For example, as written in the second row from top in the table in FIG. 6, the downsized image may be synthesized with the normal image (the downsized image may be pasted onto the normal image) to generate the transfer image (method 1-1). The normal image with which the downsized image is to be synthesized may be any image. For example, it may be an image of a past frame. For example, the transfer image may be generated by synthesizing a normal image of the past frame with a downsized image of the current frame. For example, the past frame may be the previous frame or may be a frame of the previous intra picture. In addition, the transfer image may be generated by synthesizing a normal image obtained before size-reduction of the current frame with a downsized image of the current frame.

In addition, a normal image with which a downsized image is synthesized may be an image of a frame other than past frames. For example, it may be an image whose pixels entirely have a predetermined pixel value. For example, the pixel value may be “0,” may be a value other than “0,” or may be a predetermined statistic value such as the average of pixel values of the downsized image. In addition, as what is generally called a gradation or snow image, the pixel values of the pixels are not required to be uniform values.

Note that the size (reduced size) of a downsized image can be any size as long as it is smaller than the size (normal size) of a normal image. The reduced size may have a predetermined value (fixed value) or may have a variable value. That is, the resolution control (image size control) may be control to choose either one of two choices, i.e., the normal size or the reduced size, or may be control to choose any size within the range of sizes smaller than the normal size.

In addition, the position of a downsized image in a transfer image can be any position. For example, it may be arranged such that predetermined positions such as the upper left corners of the downsized image and the transfer image are aligned. In addition, the position of the downsized image may be variable. For example, the position of the downsized image may be set adaptively such that the residue is reduced further (i.e., the coding amount is reduced further).

Note that the aspect ratio of a downsized image may be the same as or different from the aspect ratio of a normal image that has not been subjected to size-reduction. In addition, one frame of a transfer image may include multiple downsized images. By doing so, the frame rate can be controlled without the frame rate of the transfer-subject image being modified.

As written in the third row from top in the table in FIG. 6, the area other than a downsized-image area which is the portion of a downsized image included in a transfer image may be coded in a skip mode (method 1-2). By doing so, even if the downsized image is coded as the transfer image (with the normal size), a decrease of coding efficiency can be inhibited. Note that in a case where the boundary (periphery) of the downsized image is not aligned with the boundary between CUs or macroblocks, this means that there are CUs or macroblocks including both the downsized-image area and the other area. In such a case, it is sufficient if CUs or macroblocks including even a small part of the downsized image are coded with a normal method and CUs or macroblocks not including the downsized-image area are coded in the skip mode.

As written in the sixth row from top in the table in FIG. 6, downsized-image-frame information representing the position and the size of a downsized image in a transfer image may be signaled (method 1-5). For example, the downsized-image-frame information may be coded. By signaling the downsized-image-frame information, it is possible for the decoding side to easily recognize the position and the size of the downsized-image-frame area in reference to the downsized-image-frame information. Accordingly, it is possible to easily extract the downsized image. Stated differently, by signaling such downsized-image-frame information, the downsized image with any size can be arranged at any position on the transfer image. Note that the position and the size of the downsized-image area can be specified in any units. For example, they may be specified in units of pixels or may be specified in units of blocks such as CUs or macroblocks.

In addition, the downsized-image-frame information may be signaled for all frames or may be signaled only for frames that transfer downsized images, and not be signaled for frames that transfer normal images. In addition, the downsized-image-frame information may be signaled for each frame during a period in which downsized images are transferred or may be signaled only for a frame in which the image size and the position of a downsized image are changed.

Such resolution control of a transfer-subject image may be performed adaptively according to the execution transfer bandwidth of a transfer path that is used for transferring the image. That is, the actually available bandwidth of the transfer path may be observed, and the resolution control may be performed according to results of the observation. By doing so, the resolution control mentioned above can be applied to transfer rate control according to the communication environment.

In a case where the resolution of a transfer-subject image is changed by the resolution control mentioned above, as written in the fourth row from top in the table in FIG. 6, coding may be performed by setting the first picture obtained after the resolution change, as a reference picture that is not an intra picture (method 1-3). For example, in a case where the first picture obtained after the resolution change is taken at a timing when a non-reference picture as an intra picture or a B picture is to be set, coding may be performed by the non-reference picture being changed to a reference plane picture (a picture that can be referred to by another picture) as exemplified by a P picture or a stored B picture (Stored B picture) that is not an intra picture. By doing so, a decrease of coding efficiency can be inhibited.

In addition, in a case where the resolution of a transfer-subject image is changed by the resolution control mentioned above, as written in the fifth row from top in the table in FIG. 6, coding may be performed by setting the last picture obtained before the resolution change as a long term reference picture (Long term reference picture) (method 1-4). For example, in a case of a coder having the long term reference picture functionality as in AVC, HEVC, or the like, a reference plane is retained by setting the last picture obtained before the resolution change as a long term reference picture. By doing so, coding is performed in a frame in which a normal image is restored from the transfer-subject image by setting the newest long term reference picture as a reference plane, to thereby make it possible to refer to the previous normal image. In such resolution control for rate control, typically, a frame including a normal image is correlated more with another frame including a normal image than with a frame including a downsized image. Accordingly, by setting, as a long term reference picture, the last picture obtained before the resolution change in such a manner, a decrease of coding efficiency can be inhibited.

On the decoding side, as written in the eighth row from top in the table in FIG. 6, coded data including downsized images kept in normal image frames and coded in the same sequence is decoded, and the downsized images are extracted from frames with the obtained normal image frames (method 2).

For example, coded data is decoded; a transfer image that is a to-be-transferred image with a normal size including a downsized image obtained by size-reduction of a normal image whose image size is the normal size to a reduced size that is an image size smaller than the normal size is generated, and the downsized image is extracted from the generated transfer image.

For example, an image processing apparatus includes a decoding section that decodes coded data and generates a transfer image that is a to-be-transferred image with a normal size including a downsized image obtained by size-reduction of a normal image whose image size is the normal size to a reduced size that is an image size smaller than the normal size, and a downsized-image extracting section that extracts the downsized image from the transfer image generated by the decoding section.

By doing so, an image size can be changed without causing a discontinuity of a sequence, and it becomes possible to take over a reference plane before and after an image frame change; therefore, a decrease of coding efficiency due to resolution control can be inhibited.

As written in the ninth row from top in the table in FIG. 6, resolution transformation (upsampling) may be performed on a downsized image extracted in the manner mentioned above, and the image size may be expanded to a normal size (method 2-1). By doing so, a normal image with the normal size can be obtained on the decoding side. That is, the normal image can be transferred.

As mentioned above, downsized-image-frame information representing the position and the size of a downsized image in a transfer image may be signaled. That is, as written in the tenth row from top in the table in FIG. 6, in reference to the signaled downsized-image-frame information, a downsized-image area may be identified on the decoding side (method 2-2). For example, coded data may be decoded to generate downsized-image-frame information, and, in reference to the downsized-image-frame information, a downsized image may be extracted from a transfer image. By doing so, the downsized-image area can be identified more easily; therefore, extraction of the downsized image can be performed more easily. Stated differently, by applying such downsized-image-frame information, restrictions on the position, the size, and the like of a downsized-image area can be reduced.

Note that in a case where there is downsized-image-frame information corresponding to a processing-subject frame, a downsized image may be extracted from a transfer image. Stated differently, in a case where there is not downsized-image-frame information corresponding to a processing-subject frame, it may be determined that the transfer image is a normal image (a downsized image is not included), and extraction of a downsized image may be omitted. By doing so, it is possible to easily recognize whether or not a transfer image includes a downsized image, that is, whether or not extraction of a downsized image should be performed.

### 3. First Embodiment

### <Image Transmitting Apparatus>

The present technology explained above can be applied to any apparatus, device, system, and the like. For example, the present technology mentioned above can be applied to an image transmitting apparatus that transmits moving images.

FIG. 7 is a block diagram depicting an example of a configuration of an image transmitting apparatus which is a form of an image processing apparatus to which the present technology is applied. An image transmitting apparatus 100 depicted in FIG. 7 is an apparatus that codes image data of a moving image and transmits the image data to the receiving side. For example, the image transmitting apparatus 100 implements a technology described in at least any one piece of NPL mentioned above, and codes the image data of the moving image by a method conforming to a standard described in any piece of the NPL. In addition, the image transmitting apparatus 100 transmits, to the receiving side via a predetermined transfer path, coded data (bitstream) generated by the coding. The transfer path can be any transfer path, and may be a cable transfer path or may be a wireless transfer path. In addition, it may be one including a network or another communication apparatus.

Note that major ones of processing sections, data flows, and the like are depicted in FIG. 7, and those depicted in FIG. 7 are not necessarily the only ones. That is, in the image transmitting apparatus 100, there may be processing sections that are not depicted as blocks in FIG. 7, or there may be processes or data flows that are not depicted as arrows or the like in FIG. 7. The same is true also for other figures for explaining processing sections and the like in the image transmitting apparatus 100.

As depicted in FIG. 7, the image transmitting apparatus 100 has a transfer method control section 101, a resolution transforming section 111, a video capture 112, a coding section 113, and a transmitting section 114.

The transfer method control section 101 performs processes related to control of image data transfer methods. For example, the transfer method control section 101 acquires execution transfer bandwidth information which is supplied from the transmitting section 114 and is related to the currently actually available bandwidth of the transfer path. In reference to the execution transfer bandwidth information (i.e., the currently actually available bandwidth), the transfer method control section 101 controls image data transfer methods.

For example, as mentioned above in <2. Downsized-Image Transfer 1 with Normal Image Frame>, the transfer method control section 101 controls the resolution of a transfer-subject image. For example, the transfer method control section 101 controls the resolution transforming section 111 to perform the resolution control. In addition, in a case where the size of the transfer-subject image is reduced to a reduced size, the transfer method control section 101 controls the video capture 112 to synthesize the downsized image with a normal image (paste the downsized image onto the normal image).

Further, the transfer method control section 101 controls the coding section 113 to perform coding according to image size control. For example, in a case where the image size of the transfer-subject image is changed, the transfer method control section 101 supplies the coding section 113 with an image-frame switch notification to that effect. For example, in a case where the image size is changed from the normal size to a reduced size, as the image-frame switch notification, downsized-image-frame information may be supplied to the coding section 113. For example, the downsized-image-frame information may include downsized-image size information representing the image size of the downsized image. In addition, downsized-image positional information representing the position of the downsized image on the transfer image may be included in the downsized-image-frame information.

Note that the transfer method control section 101 may perform not only the resolution control, but also coding target bitrate control or frame rate control.

Further, the image-frame switch notification mentioned above may also include a picture-type change instruction for causing the first picture obtained after the resolution change to be set as a reference picture that is not an intra picture. In addition, the image-frame switch notification mentioned above may also include a long-term-reference-picture setting instruction for causing the last picture obtained before the resolution change to be set as a long term reference picture.

As mentioned above in <2. Downsized-Image Transfer 1 with Normal Image Frame>, the resolution transforming section 111 performs processes related to transformation of the resolution (image size) of a transfer-subject image. For example, the resolution transforming section 111 acquires a moving image to be input to the image transmitting apparatus 100, and, under the control of the transfer method control section 101, transforms the resolution of each frame image in the moving image as necessary. That is, in a case where an instruction is given from the transfer method control section 101, as depicted in A of FIG. 8, the resolution transforming section 111 downsamples a normal image 131 for a frame specified by the instruction, transforms the resolution from the normal size to a reduced size, and generates a downsized image 132. This reduced size may be determined beforehand or may be specified by the transfer method control section 101. In a case where resolution transformation is performed in such a manner, the resolution transforming section 111 supplies the downsized image to the video capture 112. In addition, in a case where resolution transformation is not performed, the resolution transforming section 111 supplies the normal image to the video capture 112.

As mentioned above in <2. Downsized-Image Transfer 1 with Normal Image Frame>, the video capture 112 performs processes related to generation of a transfer image. For example, the video capture 112 acquires a normal image or a downsized image from the resolution transforming section 111. In a case where the video capture 112 acquires a normal image and is controlled by the transfer method control section 101 to transfer the normal image, the video capture 112 supplies the normal image to the coding section 113 as a transfer image. Alternatively, in a case where the video capture 112 acquires a downsized image and is controlled by the transfer method control section 101 to transfer the downsized image, as depicted in B of FIG. 8, the video capture 112 generates a transfer image 133 including the downsized image 132 at a predetermined position or at a position specified by the transfer method control section 101, and supplies the transfer image 133 to the coding section 113.

As mentioned above in <2. Downsized-Image Transfer 1 with Normal Image Frame>, the coding section 113 performs processes related to coding of a transfer image. For example, the coding section 113 acquires a transfer image supplied from the video capture 112. Under the control of the transfer method control section 101, the coding section 113 codes the transfer image. For example, in a case where the coding section 113 is supplied with a transfer image that is a normal image and is controlled by the transfer method control section 101 to transfer the normal image, the coding section 113 codes the transfer image by a normal coding method. Alternatively, in a case where the coding section 113 is supplied with a transfer image including a downsized image and is controlled by the transfer method control section 101 to transfer the downsized image, as depicted in C of FIG. 8, under the control of the transfer method control section 101, the coding section 113 codes a downsized-image area 135 of the transfer image by the normal coding method, and codes the other area 136 in the skip mode.

As depicted in D of FIG. 8, the coding section 113 signals downsized-image-frame information which is information regarding such a downsized-image area. For example, the coding section 113 stores the downsized-image-frame information in a user area of SEI (Supplemental Enhancement Information). Note that the location where the downsized-image-frame information is to be stored can be any location. In addition, the downsized-image-frame information can include any piece of information. For example, downsized-image size information which is information regarding the size of the downsized image may be included. In addition, downsized-image positional information which is information regarding the position of the downsized image may be included.

In addition, in a case where the resolution of a transfer-subject image has been changed, the coding section 113 can also perform coding by setting the first picture obtained after the resolution change as a reference picture that is not an intra picture. Further, in a case where the resolution of a transfer-subject image has been changed, the coding section 113 can also perform coding by setting the last picture obtained before the resolution change as a long term reference picture. The coding section 113 supplies the transmitting section 114 with coded data generated by such coding.

The transmitting section 114 performs processes related to transmission of coded data. For example, the transmitting section 114 acquires coded data supplied from the coding section 113. In addition, the transmitting section 114 transmits the coded data as a bitstream. Further, the transmitting section 114 measures the currently actually available bandwidth of the transfer path, and generates execution transfer bandwidth information which is information regarding the available bandwidth. The transmitting section 114 supplies the execution transfer bandwidth information to the transfer method control section 101.

By doing so, the image transmitting apparatus 100 can control the resolution of a transfer-subject image without causing a discontinuity of the sequence; therefore, a decrease of coding efficiency can be inhibited.

### <Coding Section>

FIG. 9 is a block diagram depicting an example of a main configuration of the coding section 113 depicted in FIG. 7. As depicted in FIG. 9, the coding section 113 has a control section 151, a rearranging buffer 161, a calculating section 162, an orthogonal transforming section 163, a quantizing section 164, a coding section 165, and an accumulation buffer 166. In addition, the coding section 113 has an inverse quantizing section 167, an inverse orthogonal transforming section 168, a calculating section 169, an in-loop filtering section 170, a frame memory 171, a predicting section 172, and a rate control section 173.

### <Control Section>

According to a block size which is a processing unit specified externally or specified in advance, the control section 151 divides moving image data retained by the rearranging buffer 161 into blocks of the processing unit (CUs, PUs, transformation blocks, etc.). In addition, according to RDO (Rate-Distortion Optimization), for example, the control section 151 decides a coding parameter (header information Hinfo, prediction mode information Pinfo, transformation information Tinfo, filter information Finfo, etc.) to be supplied to blocks. For example, the control section 151 can set a transformation skip flag and the like.

Details of these coding parameters are described later. Upon deciding coding parameters as the ones above, the control section 151 supplies them to blocks. The specifics are as follows.

The header information Hinfo is supplied to each block. The prediction mode information Pinfo is supplied to the coding section 165 and the predicting section 172. The transformation information Tinfo is supplied to the coding section 165, the orthogonal transforming section 163, the quantizing section 164, the inverse quantizing section 167, and the inverse orthogonal transforming section 168. The filter information Finfo is supplied to the in-loop filtering section 170.

### <Rearranging Buffer>

The coding section 113 receives, as input, transfer images which are frame images of a moving image in their reproduction order (display order). The rearranging buffer 161 acquires the transfer images in their reproduction order (display order), and retains (stores) them. Under the control of the control section 151, the rearranging buffer 161 rearranges the transfer images in the coding order (decoding order), divides the transfer images into blocks of the processing unit, and so on. The rearranging buffer 161 supplies each transfer image that has been subjected to the processes to the calculating section 162.

### <Calculating Section>

The calculating section 162 subtracts a prediction image P supplied from the predicting section 172 from an image corresponding to a block of the processing unit supplied from the rearranging buffer 161, derives a prediction residue D, and supplies the prediction residue D to the orthogonal transforming section 163.

### <Orthogonal Transforming Section>

The orthogonal transforming section 163 receives, as input, the prediction residue supplied from the calculating section 162 and the transformation information Tinfo supplied from the control section 151, performs an orthogonal transformation on the prediction residue in reference to the transformation information Tinfo, and derives a transformation coefficient Coeff. The orthogonal transforming section 163 supplies the obtained transformation coefficient to the quantizing section 164.

### <Quantizing Section>

The quantizing section 164 receives, as input, the transformation coefficient supplied from the orthogonal transforming section 163 and the transformation information Tinfo supplied from the control section 151, and performs scaling (quantization) of the transformation coefficient in reference to the transformation information Tinfo. Note that the rate of this quantization is controlled by the rate control section 173. The quantizing section 164 supplies the coding section 165 and the inverse quantizing section 167 with the post-quantization transformation coefficient (also referred to as a quantization transformation coefficient level) level obtained by such quantization.

### <Coding Section>

The coding section 165 receives, as input, the quantization transformation coefficient level supplied from the quantizing section 164, the various types of coding parameters (the header information Hinfo, the prediction mode information Pinfo, the transformation information Tinfo, the filter information Finfo, etc.) supplied from the control section 151, information regarding a filter such as a filter coefficient supplied from the in-loop filtering section 170, and information regarding an optimum prediction mode supplied from the predicting section 172.

For example, the coding section 165 performs entropy coding (lossless coding) such as CABAC (Context-based Adaptive Binary Arithmetic Code) or CAVLC (Context-based Adaptive Variable Length Code) on the quantization transformation coefficient level, and generates a bit string (coded data).

In addition, the coding section 165 derives residue information Rinfo from the quantization transformation coefficient level, codes the residue information Rinfo, and generates a bit string.

Further, the coding section 165 includes, in the filter information Finfo, the information regarding the filter supplied from the in-loop filtering section 170, and includes, in the prediction mode information Pinfo, the information regarding the optimum prediction mode supplied from the predicting section 172. Further, the coding section 165 codes the various types of coding parameters (the header information Hinfo, the prediction mode information Pinfo, the transformation information Tinfo, the filter information Finfo, etc.) mentioned above, and generates a bit string.

In addition, the coding section 165 multiplexes the thus-generated bit strings of the various types of information, and generates coded data. The coding section 165 supplies the coded data to the accumulation buffer 166.

### <Accumulation Buffer>

The accumulation buffer 166 temporarily retains the coded data obtained at the coding section 165. At a predetermined timing, the accumulation buffer 166 supplies the retained coded data (bitstream) to the transmitting section 114.

### <Inverse Quantizing Section>

The inverse quantizing section 167 performs processes related to inverse quantization. For example, the inverse quantizing section 167 receives, as input, the quantization transformation coefficient level level supplied from the quantizing section 164 and the transformation information Tinfo supplied from the control section 151, and performs scaling (inverse quantization) of the value of the quantization transformation coefficient level in reference to the transformation information Tinfo. Note that this inverse quantization is an inverse process of the quantization performed at the quantizing section 164. The inverse quantizing section 167 supplies a transformation coefficient Coeff_IQ obtained by such inverse quantization to the inverse orthogonal transforming section 168. Note that since the inverse quantizing section 167 is similar to an inverse quantizing section (mentioned later) on the decoding side, an explanation (mentioned later) that is given with respect to the decoding side can be applied to the inverse quantizing section 167.

### <Inverse Orthogonal Transforming Section>

The inverse orthogonal transforming section 168 performs processes related to an inverse orthogonal transformation. For example, the inverse orthogonal transforming section 168 receives, as input, the transformation coefficient supplied from the inverse quantizing section 167 and the transformation information Tinfo supplied from the control section 151, performs an inverse orthogonal transformation on the transformation coefficient in reference to the transformation information Tinfo, and derives a prediction residue D′. Note that this inverse orthogonal transformation is an inverse process of the orthogonal transformation performed at the orthogonal transforming section 163. The inverse orthogonal transforming section 168 supplies the prediction residue obtained by such an inverse orthogonal transformation to the calculating section 169. Note that because the inverse orthogonal transforming section 168 is similar to an inverse orthogonal transforming section (mentioned later) on the decoding side, an explanation (mentioned later) that is given with respect to the decoding side can be applied to the inverse orthogonal transforming section 1168.

### <Calculating Section>

The calculating section 169 receives, as input, the prediction residue D′ supplied from the inverse orthogonal transforming section 168 and the prediction image P supplied from the predicting section 172. The calculating section 169 adds together the prediction residue and the prediction image corresponding to the prediction residue, and derives a locally-decoded image. The calculating section 169 supplies the derived locally-decoded image to the in-loop filtering section 170 and the frame memory 171.

### <In-Loop Filtering Section>

The in-loop filtering section 170 performs processes related to an in-loop filtering process. For example, the in-loop filtering section 170 receives, as input, the locally-decoded image supplied from the calculating section 169, the filter information Finfo supplied from the control section 151, and the transfer image (original image) supplied from the rearranging buffer 161. Note that information to be input to the in-loop filtering section 170 can be any piece of information, and information other than these pieces of information may be input. For example, as necessary, information regarding a prediction mode, motion information, a coding amount target value, a quantization parameter QP, a picture type, or a block (CU, CTU, etc.) or the like may be input to the in-loop filtering section 120.

The in-loop filtering section 170 performs a filtering process as appropriate on the locally-decoded image in reference to the filter information Finfo. As necessary, for the filtering process, the in-loop filtering section 170 uses also the transfer image (original image) and other pieces of input information.

For example, the in-loop filtering section 170 can apply four in-loop filters, which are a bilateral filter, a deblocking filter (DBF (DeBlocking Filter)), an adaptive offset filter (SAO (Sample Adaptive Offset)), and an adaptive loop filter (ALF (Adaptive Loop Filter)), in this order as described in NPL 1. Note that filters to be applied can be any filters, and the order that the filters are applied can be any order. These can be selected as appropriate.

Certainly, the filtering process to be performed by the in-loop filtering section 170 can be any filtering process, and is not limited to the example mentioned above. For example, the in-loop filtering section 170 may apply the Wiener filter or the like.

The in-loop filtering section 170 supplies the frame memory 171 with the locally-decoded image having been subjected to the filtering process. Note that, for example, in a case where information regarding filters such as filter coefficients is transferred to the decoding side, the in-loop filtering section 170 supplies the information regarding the filters to the coding section 165.

### <Frame Memory>

The frame memory 171 performs processes related to storage of data related to an image. For example, the frame memory 171 receives, as input, the locally-decoded image supplied from the calculating section 169 and the locally-decoded image having been subjected to the filtering process supplied from the in-loop filtering section 170, and retains (stores) them. In addition, the frame memory 171 reconstructs the decoded image for each picture unit by using the locally-decoded image, and retains the decoded image (stores it in a buffer in the frame memory 171). The frame memory 171 supplies the decoded image (or part thereof) to the predicting section 172 in response to a request from the predicting section 172.

### <Predicting Section>

The predicting section 172 performs processes related to generation of a prediction image. For example, the predicting section 172 receives, as input, the prediction mode information Pinfo supplied from the control section 151, the transfer image (original image) supplied from the rearranging buffer 161, and the decoded image (or part thereof) read out from the frame memory 171. The predicting section 172 performs a prediction process such as an inter-prediction or an intra-prediction by using the prediction mode information Pinfo and the transfer image (original image), performs prediction by referring to the decoded image as a reference image, performs a motion compensation process according to a result of the prediction, and generates the prediction image. The predicting section 172 supplies the generated prediction image to the calculating section 162 and the calculating section 169. In addition, as necessary, the predicting section 172 supplies the coding section 165 with information regarding a prediction mode selected in the processes above, that is, an optimum prediction mode.

### <Rate Control Section>

The rate control section 173 performs processes related to rate control. For example, the rate control section 173 controls the rate of a quantization operation of the quantizing section 164 such that an overflow or an underflow does not occur, according to the coding amount of coded data accumulated in the accumulation buffer 166.

### <Coding Control>

As mentioned above, the coding section 113 performs processes on an input transfer image. That is, in a case where a transfer image includes a downsized image, the control section 151 controls each processing section to code blocks other than a downsized-image area in the skip mode. In addition, the control section 151 controls the coding section 165 to signal downsized-image-frame information. Moreover, in a case where the resolution of a transfer-subject image has been changed, the control section 151 controls each processing section to perform coding by setting the first picture obtained after the resolution change as a reference picture that is not an intra picture. In addition, in a case where the resolution of a transfer-subject image has been changed, the control section 151 controls wrong processing sections to perform coding by setting the last picture obtained before the resolution change as a long term reference picture.

By doing so, the coding section 113 can inhibit a decrease of coding efficiency.

### <Procedure of Image Transmission Process>

Next, an example of the procedure of an image transmission process executed by the image transmitting apparatus 100 is explained with reference to a flowchart in FIG. 10.

When the image transmission process is started, in Step S101, the transmitting section 114 of the image transmitting apparatus 100 measures the available band of a transfer path, and generates execution transfer bandwidth information.

In Step S102, the transfer method control section 101 executes a transfer method control process, and performs control of the resolution of a transfer-subject image and the like.

In Step S103, according to the transfer method control performed at the process in Step S102, the resolution transforming section 111 performs downsampling as appropriate, and transforms the resolution of the transfer-subject image.

In Step S104, according to the transfer method control performed at the process in Step S102, the video capture 112 generates a transfer image (a frame image with the normal size) by using a normal image or a downsized image.

In Step S105, according to the transfer method control performed at the process in Step S102, the coding section 113 executes a coding process, and codes the transfer image (the frame image with the normal size).

In Step S106, the transmitting section 114 transmits a bitstream on which the rate control has been performed in the manner mentioned above.

In Step S107, the transfer method control section 101 determines whether or not to end the image transmission process. In a case where transmission of the moving image has not ended (there is an unprocessed frame) and the image transmission process is determined not to be ended, the process returns to Step S101. Alternatively, in a case where it is determined in Step S107 that all the frames have been processed, the image transmission process is ended.

### <Procedure of Transfer Method Control Process>

Next, an example of the procedure of the transfer method control process executed in Step S102 in FIG. 10 is explained with reference to a flowchart in FIG. 11.

When the transfer method control process is started, in Step S121, the transfer method control section 101 acquires execution transfer bandwidth information from the transmitting section 114.

In Step S122, in reference to the execution transfer bandwidth information, the transfer method control section 101 determines whether or not to change the resolution (image size) of the transfer-subject image from a normal setting (normal size) to a reduction setting (reduced size). In a case where the resolution is determined to be changed, the process proceeds to Step S123.

In Step S123, the transfer method control section 101 controls the resolution transforming section 111 to start resolution transformation (downsampling) from the normal size to the reduced size.

In Step S124, the transfer method control section 101 controls the video capture 112 to start pasting of the downsized image onto the normal image frame (i.e., generation of a transfer image with the normal size including the downsized image).

In Step S125, the transfer method control section 101 notifies the coding section 113 that the image frame is to be switched (that the resolution of the transfer-subject image is to be changed from the normal size to the reduced size), and causes the coding section 113 to perform coding of the transfer image including the downsized image.

When Step S125 is ended, the transfer method control process is ended, and the process returns to FIG. 10.

In addition, in a case where it is determined in Step S122 that the resolution is not to be changed from the normal setting to the reduction setting, the process proceeds to Step S126.

In Step S126, in reference to the execution transfer bandwidth information acquired in Step S121, the transfer method control section 101 determines whether or not to change the resolution (image size) of the transfer-subject image from a reduction setting (reduced size) to a normal setting (normal size). In a case where the resolution is determined to be changed, the process proceeds to Step S127.

In Step S127, the transfer method control section 101 controls the resolution transforming section 111 to end the resolution transformation (downsampling) from the normal size to the reduced size.

In Step S128, the transfer method control section 101 controls the video capture 112 to end the pasting of the downsized image onto the normal image frame (i.e., the generation of the transfer image with the normal size including the downsized image).

In Step S129, the transfer method control section 101 notifies the coding section 113 that the image frame is to be switched (that the resolution of the transfer-subject image is to be changed from the reduced size to the normal size), and causes the coding section 113 to perform coding of the transfer image including the normal image.

When Step S129 is ended, the transfer method control process is ended, and the process returns to FIG. 10.

In addition, in a case where it is determined in Step S126 not to change the resolution from the reduction setting to the normal setting, the transfer method control process is ended, and the process returns to FIG. 10.

### <Procedure of Coding Process>

Next, an example of the procedure of the coding process executed in Step S105 in FIG. 10 is explained with reference to a flowchart in FIG. 12.

When the coding process is started, in Step S141, the control section 151 of the coding section 113 determines whether or not it is instructed by the transfer method control section 101 to switch the image frame (change the resolution of the transfer-subject image). In a case where it is determined that the control section 151 is instructed to do so, the process proceeds to Step S142.

In Step S142, the control section 151 retains the image frame information.

In Step S143, the control section 151 sets the last picture in the display order obtained before the image frame change (before the resolution change) as a long term reference picture.

In Step S144, the control section 151 retains information regarding the long term reference picture associated with the image frame size.

In Step S145, the control section 151 determines whether or not the first picture in the display order used after the image frame change is a reference picture (a picture that can be referred to) other than an intra picture. In a case where it is determined that it is not a reference picture other than an intra picture, the process proceeds to Step S146.

In Step S146, the control section 151 sets the first picture in the display order used after the image frame change as a reference picture other than an intra picture. When the process in Step S146 is ended, the process proceeds to Step S147. In addition, in a case where it is determined in Step S145 that the first picture in the display order used after the image frame change is a reference picture other than an intra picture, the process proceeds to Step S147.

In Step S147, the control section 151 determines whether or not there is a long term reference picture having an image frame size which is the same as the current image frame size. In a case where it is determined that there is such a long term reference picture, the process proceeds to Step S148.

In Step S148, the control section 151 sets, as a reference plane, the long term reference picture having the image frame size which is the same as the current image frame size. When the process in Step S148 is ended, the process proceeds to Step S149. In addition, in a case where it is determined in Step S147 that there is not a long term reference picture having an image frame size which is the same as the current image frame size, the process proceeds to Step S149. Furthermore, in a case where it is determined in Step S141 that the control section 151 is not instructed to switch the image frame, the process proceeds to Step S149.

In Step S149, the control section 151 determines whether or not the processing-subject frame (transfer image) is a transfer image that is a normal image. In a case where it is determined that it is a transfer image that is a normal image, the process proceeds to Step S150.

In Step S150, the coding section 113 performs a normal image coding process, and performs a coding process on a transfer image that is a normal image. When the process in Step S150 is ended, the coding process is ended, and the process returns to FIG. 10.

In addition, in a case where it is determined in Step S149 that the processing-subject frame (transfer image) is a transfer image including a downsized image, the process proceeds to Step S151.

In Step S151, the coding section 113 executes a downsized-image coding process, and performs a coding process on the transfer image including the downsized image. When the process in Step S151 is ended, the coding process is ended, and the process returns to FIG. 10.

### <Procedure of Normal Image Coding Process>

Next, an example of the procedure of the normal image coding process executed in Step S150 in FIG. 12 is explained with reference to a flowchart in FIG. 13.

When the normal image coding process is started, in Step S171, under the control of the control section 151, the rearranging buffer 161 rearranges frames of input moving image data arranged in a display order, such that the frames are arranged in a coding order.

In Step S172, the control section 151 sets a processing unit for (performs block division on) an input image (transfer image) retained in the rearranging buffer 161.

In Step S173, the control section 151 decides (sets) a coding parameter for the transfer image retained in the rearranging buffer 161.

In Step S174, the predicting section 172 performs a prediction process, and generates a prediction image and the like of an optimum prediction mode. For example, in this prediction process, the predicting section 172 performs an intra-prediction to generate a prediction image and the like of an optimum intra-prediction mode, performs an inter-prediction to generate a prediction image and the like of an optimum inter-prediction mode, and selects an optimum prediction mode from them according to a cost function value and the like.

In Step S175, the calculating section 162 calculates a difference between the input image (transfer image) and the prediction image of the optimum mode selected by the prediction process in Step S174. That is, the calculating section 162 generates a prediction residue D of the input image (transfer image) and the prediction image. The thus-determined prediction residue D allows a reduction of the amount of data as compared with the original image data. Accordingly, as compared with the case where an image itself is coded, the amount of data can be compressed.

In Step S176, in accordance with the transformation mode information generated in Step S173, the orthogonal transforming section 163 performs an orthogonal transformation process on the prediction residue D generated by the process in Step S175, and derives the transformation coefficient Coeff.

In Step S177, the quantizing section 164 uses the quantization parameter computed by the control section 151, for example, to quantize the transformation coefficient Coeff obtained by the process in Step S176, and derives the quantization transformation coefficient level level.

In Step S178, by using a characteristic corresponding to a characteristic of the quantization in Step S177, the inverse quantizing section 167 performs inverse quantization on the quantization transformation coefficient level level generated by the process in Step S177, and derives the transformation coefficient Coeff_IQ.

In Step S179, in accordance with the transformation mode information generated in Step S173, the inverse orthogonal transforming section 168 performs an inverse orthogonal transformation on the transformation coefficient Coeff_IQ obtained by the process in Step S178 by a method corresponding to the orthogonal transformation process in Step S176, and derives a prediction residue D′. Note that because this inverse orthogonal transformation process is similar to an inverse orthogonal transformation process (mentioned later) performed on the decoding side, an explanation (mentioned later) given with respect to the decoding side can be applied to the inverse orthogonal transformation process in Step S179.

In Step S180, the calculating section 169 adds the prediction image obtained by the prediction process in Step S174 to the prediction residue D′ derived by the process in Step S179, to thereby generate a locally-decoded decoded image.

In Step S181, the in-loop filtering section 170 performs an in-loop filtering process on the locally-decoded decoded image derived by the process in Step S180.

In Step S182, the frame memory 171 stores the locally-decoded decoded image derived by the process in Step S180 and the locally-decoded decoded image having been subjected to the filtering process in Step S181.

In Step S183, the coding section 165 codes the quantization transformation coefficient level level obtained by the process in Step S177 and the transformation mode information generated in Step S173. For example, the coding section 165 codes the quantization transformation coefficient level level which is information regarding the image by arithmetic coding or the like, and generates coded data. In addition, at this time, the coding section 165 codes various types of coding parameters (the header information Hinfo, the prediction mode information Pinfo, and the transformation information Tinfo). Furthermore, the coding section 165 derives residue information RInfo from the quantization transformation coefficient level level, and codes the residue information RInfo.

In Step S184, the accumulation buffer 166 accumulates the thus-obtained coded data, and supplies the coded data to the transmitting section 114 as a bitstream, for example. The bitstream is transferred to the decoding side via a transfer path or a recording medium, for example. In addition, the rate control section 173 performs rate control as necessary.

When the process in Step S184 is ended, the normal image coding process is ended, and the process returns to FIG. 12.

### <Procedure of Downsized-Image Coding Process>

Next, an example of the procedure of the downsized-image coding process executed in Step S151 in FIG. 12 is explained with reference to a flowchart in FIG. 14.

When the downsized-image coding process is started, processes in Step S201 to Step S203 are executed similarly to the processes in Step S171 to Step S173 in the normal image coding process in FIG. 13.

In Step S204, the control section 151 determines whether or not the processing-subject block is a downsized-image area which is the area of the downsized image included in the transfer image (or includes the downsized-image area). In a case where it is determined that the processing-subject block is a downsized-image area (or includes the downsized-image area), the process proceeds to Step S205.

Processes in Step S205 to Step S211 are executed similarly to the processes in Step S174 to Step S180 in the normal image coding process in FIG. 13. When the process in Step S211 is ended, the process proceeds to Step S213.

In addition, in a case where it is determined in Step S204 that the processing-subject block is not a downsized-image area (or does not include the downsized-image area), the process proceeds to Step S212.

In Step S212, the control section 151 applies the skip mode to this block. That is, coding of a residue, a motion vector, or the like is omitted for this block. When the process in Step S212 is ended, the process proceeds to Step S213.

Processes in Step S213 to Step S216 are executed similarly to the processes in Step S181 to Step S184 in the normal image coding process in FIG. 13.

When the process in Step S216 is ended, the downsized-image coding process is ended.

By executing the processes in the manner mentioned above, the image transmitting apparatus 100 can control the resolution of a transfer-subject image without causing a discontinuity of the sequence; therefore, a decrease of coding efficiency can be inhibited.

### <How Coding Is Performed>

For example, it is supposed that in a case where frames 201 to 206 are transferred as in FIG. 15, the sizes of the frame 203 and the frame 204 are reduced. In that case, a downsized-image area 211 of the frame 203 refers to an area A of the frame 202. The image of the downsized-image area 211 is a downsized image, and the area A correlated with the downsized-image area 211 is set as a reference plane. In addition, the downsized-image area 211 correlated with a downsized-image area 213 of the frame 204 is set as a reference plane of the downsized-image area 213. Moreover, the downsized-image area 213 correlated with an area C of the frame 205 is set as a reference plane of the area C. Accordingly, a decrease of coding efficiency can be inhibited.

In addition, the skip mode is applied to an area 212 other than the downsized-image area 211 of the frame 203, and the image of an area B of the frame 202 is taken over. Similarly, the skip mode is applied also to an area 214 other than the downsized-image area 213 of the frame 204, and the image of the area B of the frame 202 is taken over. Since an area D of the frame 205 refers to the area 214 of the frame 204, substantially, the correlated area A of the frame 202 can be used as a reference plane.

In such a manner, correlated reference planes can be used. For example, since even a frame in which the resolution switches as in an example in FIG. 16 can be processed without a discontinuity of the sequence being caused, a decrease of coding efficiency can be inhibited. In addition, even in a case where the resolution switches frequently as in an example in FIG. 17, a decrease of coding efficiency can be inhibited by use of correlated reference planes as in the example in FIG. 15.

Moreover, it is supposed that in a case where frames 251 to 257 are transferred as in an example in FIG. 18, the sizes of the frame 253, the frame 254, and the frame 257 are reduced. In such a case, the frame 252, the frame 254, and the frame 256 prior to the resolution changes (image frame changes) are set as long term reference pictures.

By doing so, the frame 255, which is a normal image, can be coded with reference to the frame 252, which is a normal image. In addition, a downsized-image area 262 of the frame 257 can be coded with reference to a downsized-image area 261 of the frame 254. That is, more correlated images can be referred to; therefore, a decrease of coding efficiency can be inhibited.

### 4. Second Embodiment

### <Image Receiving Apparatus>

For example, the present technology mentioned above can be applied to an image receiving apparatus that receives coded data of moving images.

FIG. 19 is a block diagram depicting an example of a configuration of an image receiving apparatus which is a form of an image processing apparatus to which the present technology is applied. An image receiving apparatus 300 depicted in FIG. 19 is an apparatus that receives and decodes coded data and generates (restores) image data of a moving image. For example, the image receiving apparatus 300 implements a technology described in at least any one piece of NPL mentioned above, receives and decodes coded data by a method conforming to a standard described in any piece of NPL, and generates (restores) image data of a moving image. For example, the image receiving apparatus 300 receives and processes coded data (bitstream) transmitted from the image transmitting apparatus 100 explained in the first embodiment.

Note that major ones of processing sections, data flows, and the like are depicted in FIG. 19, and those depicted in FIG. 19 are not necessarily the only ones. That is, in the image receiving apparatus 300, there may be processing sections that are not depicted as blocks in FIG. 19, or there may be processes or data flows that are not depicted as arrows or the like in FIG. 19. The same is true also for other figures for explaining processing sections and the like in the image receiving apparatus 300.

As depicted in FIG. 19, the image receiving apparatus 300 has a resolution control section 301, a receiving section 311, a decoding section 312, a crop processing section 313, and a resolution transforming section 314.

The resolution control section 301 performs processes related to control of resolution. For example, according to an image-frame switch notification supplied from the decoding section 312, the resolution control section 301 controls the crop processing section 313 and the resolution transforming section 314. That is, in a case where a transfer image includes a downsized image, the resolution control section 301 controls the crop processing section 313 to extract the downsized image, and controls the resolution transforming section 314 to upsample the downsized image and transform the resolution from a reduced size to the normal size (i.e., generate a normal image).

The receiving section 311 receives a transferred bitstream, and supplies the bitstream to the decoding section 312.

The decoding section 312 performs processes related to decoding. For example, the decoding section 312 acquires a bitstream (coded data) supplied from the receiving section 311. The decoding section 312 decodes the coded data, and generates (restores) a transfer image. The decoding section 312 supplies the transfer image to the crop processing section 313. In addition, the decoding section 312 determines whether the transfer image includes a normal image or includes a downsized image, and supplies an image-frame switch notification to the resolution control section 301 as necessary.

For example, in reference to downsized-image-frame information included in the bitstream, the decoding section 312 checks whether or not the transfer image includes a downsized image. In a case where the resolution of the transfer-subject image switches, the decoding section 312 gives the resolution control section 301 a notification to that effect by the image-frame switch notification. In addition, the decoding section 312 supplies the downsized-image-frame information to the resolution control section 301 as necessary.

The crop processing section 313 performs processes related to cropping of a downsized image. For example, the crop processing section 313 acquires a transfer image supplied from the decoding section 312. In a case where the transfer image includes a downsized image, under the control of the resolution control section 301, the crop processing section 313 extracts the downsized image from the transfer image, and supplies the downsized image to the resolution transforming section 314. In addition, in a case where the transfer image includes a normal image, under the control of the resolution control section 301, the crop processing section 313 supplies the transfer image to the resolution transforming section 314 as a normal image.

The resolution transforming section 314 performs processes related to transformation of resolution. For example, the resolution transforming section 314 acquires a downsized image or a normal image supplied from the crop processing section 313. In a case where the resolution transforming section 314 acquires a downsized image, under the control of the resolution control section 301, the resolution transforming section 314 upsamples the downsized image, and transforms the downsized image to a normal image. The resolution transforming section 314 outputs the normal image.

By doing so, the image receiving apparatus 300 can control the resolution of a transfer-subject image without causing a discontinuity of the sequence; therefore, a decrease of coding efficiency can be inhibited.

### <Decoding Section>

FIG. 20 is a block diagram depicting an example of a main configuration of the decoding section 312.

In FIG. 20, the decoding section 312 includes a control section 351, an accumulation buffer 361, a decoding section 362, an inverse quantizing section 363, an inverse orthogonal transforming section 364, a calculating section 365, an in-loop filtering section 366, a rearranging buffer 367, a frame memory 368, and a predicting section 369. Note that the predicting section 369 includes an intra-prediction section and an inter-prediction section that are not depicted.

### <Control Section>

The control section 351 controls decoding in reference to information accumulated in the accumulation buffer 361. In addition, in reference to the information, the control section 351 detects switching of an image frame (resolution) of a transfer-subject image, and gives the resolution control section 301 a notification to that effect.

### <Accumulation Buffer>

The accumulation buffer 361 acquires a bitstream input to the decoding section 312, and retains (stores) it. At a predetermined timing, or in a case where a predetermined condition is satisfied or in other similar cases, the accumulation buffer 361 extracts coded data included in the accumulated bitstream, and supplies the coded data to the decoding section 362.

### <Decoding Section>

The decoding section 362 performs processes related to decoding of an image. For example, the decoding section 362 receives, as input, coded data supplied from the accumulation buffer 361, performs entropy decoding (lossless decoding) of a syntax value of each syntax element from the bit string in line with the definition of a syntax table, and derives parameters.

The parameters derived from the syntax elements and the syntax values of the syntax elements include such information as the header information Hinfo, the prediction mode information Pinfo, the transformation information Tinfo, the residue information Rinfo, or the filter information Finfo, for example. That is, the decoding section 362 parses the bitstream to obtain these pieces of information (analyzes the bitstream to acquire these pieces of information). These pieces of information are explained below.

### <Header Information Hinfo>

The header information Hinfo includes such header information as VPS (Video Parameter Set) /SPS (Sequence ParameterSet)/PPS (Picture Parameter Set) /PH (picture header) /SH (slice header), for example. The header information Hinfo includes information defining image sizes (a width PicWidth, a height PicHeight); bit depths (a luminance bitDepthY, a color difference bitDepthC); a color difference array type ChromaArrayType; the maximum value MaxCUSize/minimum value MinCUSize of CU sizes; the maximum depth MaxQTDepth/minimum depth MinQTDepth of quad-tree division (also referred to as Quad-tree division); the maximum depth MaxBTDepth/minimum depth MinBTDepth of binary-tree division (Binary-tree division); the maximum value MaxTSSize of transformation skip blocks (also referred to as the maximum transformation skip block size); an On/Off flag of each coding tool (also referred to as a validity flag); and the like, for example.

For example, On/Off flags of coding tools included in the header information Hinfo include an On/Off flag related to transformation and quantization processes illustrated below. Note that the On/Off flags of the coding tools can be interpreted as being flags representing whether or not there is syntax related to the coding tools in coded data. In addition, in a case where the value of an On/Off flag is 1 (true), this represents that the coding tool is available, and in a case where the value of the On/Off flag is 0 (false), this represents that the coding tool is unavailable. Note that the interpretation of flag values may be opposite.

A cross-component prediction validity flag (ccp_enabled_flag): flag information representing whether or not a cross-component prediction (CCP (Cross-Component Prediction), also referred to as a CC prediction) is available. For example, in a case where the flag information is set to “1” (true), this represents that the prediction is available, and in a case where the flag information is set to “0” (false), this represents that the prediction is unavailable.

Note that this CCP is also referred to as a cross-component linear prediction (CCLM or CCLMP).

### <Prediction Mode Information Pinfo>

The prediction mode information Pinfo includes such information as size information PBSize (prediction block size) of a processing-subject PB (prediction block), intra-prediction mode information IPinfo, or motion prediction information MVinfo, for example.

The intra-prediction mode information IPinfo includes prev_intra_luma_pred_flag, mpm_idx, and rem_intra_pred_mode in JCTVC-W1005, 7.3.8.5 Coding Unit syntax, a luminance intra-prediction mode IntraPredModeY derived from the syntax, and the like, for example.

In addition, the intra-prediction mode information IPinfo includes a cross-component prediction flag (ccp_flag (cclmp_flag)), a multi-class linear prediction mode flag (mclm_flag), a color difference sample position type identifier (chroma_sample_loc_type_idx), a color difference MPM identifier (chroma_mpm_idx), a luminance intra-prediction mode (IntraPredModeC) derived from the syntax, and the like, for example.

The cross-component prediction flag (ccp_flag (cclmp_flag)) is flag information representing whether or not to apply a cross-component linear prediction. For example, when ccp_flag==1, this represents that a cross-component prediction is applied, and when ccp_flag==0, this represents that a cross-component prediction is not applied.

The multi-class linear prediction mode flag (mclm_flag) is information (linear prediction mode information) related to a linear prediction mode. More specifically, the multi-class linear prediction mode flag (mclm_flag) is flag information representing whether or not the mode is to be set to a multi-class linear prediction mode. For example, in a case where the multi-class linear prediction mode flag is set to “0,” this represents that the mode is a 1-class mode (single class mode) (e.g., CCLMP), and in a case where the multi-class linear prediction mode flag is set to “1,” this represents that the mode is a 2-class mode (multi-class mode) (e.g., MCLMP).

The color difference sample position type identifier (chroma_sample_loc_type_idx) is an identifier that identifies the type (also referred to as the color difference sample position type) of the pixel position of a color difference component.

Note that this color difference sample position type identifier (chroma_sample_loc_type_idx) is transferred as information (chroma_sample_loc_info()) regarding the pixel position of the color difference component (in a state in which the color difference sample position type identifier is stored in the information).

The color difference MPM identifier (chroma_mpm_idx) is an identifier representing which prediction mode candidate in a color difference intra-prediction mode candidate list (intraPredModeCandListC) is specified as the color difference intra-prediction mode.

The motion prediction information MVinfo includes such information as merge_idx, merge_flag, inter_pred_idc, ref_idx_LX, mvp_1X_flag, X={0,1}, or mvd (see JCTVC-W1005, 7.3.8.6 Prediction Unit Syntax, for example), for example.

Certainly, information to be included in the prediction mode information Pinfo can be any piece of information, and information other than these pieces of information may be included.

### <Transformation Information Tinfo>

The transformation information Tinfo includes the following pieces of information, for example. Certainly, information to be included in the transformation information Tinfo can be any piece of information, and information other than these pieces of information may be included.

A width size TBWSize and a height TBHSize of a processing-subject transformation block (or logarithmic values log2TBWSize and log2TBHSize of TBWSize and TBHSize, respectively, whose base is 2 may be used). A transformation skip flag (ts_flag): a flag representing whether or not to skip a (an inverse) primary transformation and a (an inverse) secondary transformation.
A scan identifier (scanIdx)
A quantization parameter (qp)
A quantization matrix (scaling_matrix (e.g., JCTVC-W1005, 7.3.4 Scaling list data syntax))

### <Residue Information Rinfo>

The residue information Rinfo (see 7.3.8.11 Residual Coding syntax in JCTVC-W1005, for example) includes the following syntax, for example.

cbf (coded_block_flag): a residue data presence/absence flag
last_sig_coeff_x_pos: a last non-zero coefficient X coordinate
last_sig_coeff_y_pos: a last non-zero coefficient Y coordinate
coded_sub_block_flag: a subblock non-zero coefficient presence/absence flag
sig_coeff_flag: a non-zero coefficient presence/absence flag
gr1_flag: a flag representing whether the level of a non-zero coefficient is greater than 1 (also referred to as a GR1 flag)
gr2_flag: a flag representing whether the level of the non-zero coefficient is greater than 2 (also referred to as a GR2 flag)
sign_flag: a sign representing whether the non-zero coefficient is a positive coefficient or a negative coefficient (also referred to as a sign code)
coeff_abs_level_remaining: a remaining level of the non-zero coefficient (also referred to as a non-zero coefficient remaining level)
etc.

Certainly, information to be included in the residue information Rinfo can be any piece of information, and information other than these pieces of information may be included.

### <Filter Information Finfo>

The filter information Finfo includes control information regarding each filtering process depicted below, for example.

Control information regarding a deblocking filter (DBF)
Control information regarding a pixel adaptive offset (SAO)
Control information regarding an adaptive loop filter (ALF)
Control information regarding other linear/non-linear filters

More specifically, the filter information Finfo includes information specifying a picture or an area in a picture to which each filter is applied, filter On/Off control information for each CU, filter On/Off control information regarding the boundaries of slices and tiles, and the like, for example. Certainly, information to be included in the filter information Finfo can be any piece of information, and information other than these pieces of information may be included.

Described again, the decoding section 362 derives the quantization transformation coefficient level level of each coefficient position in each transformation block by referring to the residue information Rinfo. The decoding section 362 supplies the quantization transformation coefficient level to the inverse quantizing section 363.

In addition, the decoding section 362 supplies blocks with the header information Hinfo, the prediction mode information Pinfo, the transformation information Tinfo, and the filter information Finfo that are obtained by parsing. The specifics are as follows.

The header information Hinfo is supplied to the inverse quantizing section 363, the inverse orthogonal transforming section 364, the predicting section 369, and the in-loop filtering section 366. The prediction mode information Pinfo is supplied to the inverse quantizing section 363 and the predicting section 369. The transformation information Tinfo is supplied to the inverse quantizing section 363 and the inverse orthogonal transforming section 364. The filter information Finfo is supplied to the in-loop filtering section 366.

Certainly, the examples mentioned above are examples, and those are not the sole examples. For example, each coding parameter may be supplied to any processing section. In addition, other information may be supplied to any processing section.

### <Inverse Quantizing Section>

The inverse quantizing section 363 performs processes related to inverse quantization. For example, the inverse quantizing section 363 receives, as input, the transformation information Tinfo and the quantization transformation coefficient level level supplied from the decoding section 362, performs scaling (inverse quantization) of the value of the quantization transformation coefficient level in reference to the transformation information Tinfo, and derives the transformation coefficient Coeff_IQ obtained after the inverse quantization.

Note that this inverse quantization is performed as an inverse process of the quantization performed by the quantizing section 164. In addition, this inverse quantization is a process similar to the inverse quantization performed by the inverse quantizing section 167. That is, the inverse quantizing section 167 performs processes (inverse quantization) similar to the processes performed by the inverse quantizing section 363.

The inverse quantizing section 363 supplies the derived transformation coefficient Coeff_IQ to the inverse orthogonal transforming section 364.

### <Inverse Orthogonal Transforming Section>

The inverse orthogonal transforming section 364 performs processes related to an inverse orthogonal transformation. For example, the inverse orthogonal transforming section 364 receives, as input, the transformation coefficient Coeff_IQ supplied from the inverse quantizing section 363, and the transformation information Tinfo supplied from the decoding section 362, performs an inverse orthogonal transformation process (inverse transformation process) on the transformation coefficient in reference to the transformation information Tinfo, and derives a prediction residue D′.

Note that this inverse orthogonal transformation is performed as an inverse process of the orthogonal transformation performed by the orthogonal transforming section 163. In addition, this inverse orthogonal transformation is a process similar to the inverse orthogonal transformation performed by the inverse orthogonal transforming section 168. That is, the inverse orthogonal transforming section 168 performs processes (inverse orthogonal transformation) similar to the processes performed by the inverse orthogonal transforming section 364.

The inverse orthogonal transforming section 364 supplies the derived prediction residue D′ to the calculating section 365.

### <Calculating Section>

The calculating section 365 performs processes related to addition of information regarding an image. For example, the calculating section 365 receives, as input, the prediction residue supplied from the inverse orthogonal transforming section 364 and the prediction image supplied from the predicting section 369. The calculating section 365 adds together the prediction residue and the prediction image (prediction signal) corresponding to the prediction residue, and derives a locally-decoded image.

The calculating section 365 supplies the derived locally-decoded image to the in-loop filtering section 366 and the frame memory 368.

### <In-Loop Filtering Section>

The in-loop filtering section 366 performs processes related to an in-loop filtering process. For example, the in-loop filtering section 366 receives, as input, the locally-decoded image supplied from the calculating section 365 and the filter information Finfo supplied from the decoding section 362. Note that information to be input to the in-loop filtering section 366 can be any piece of information, and information other than these pieces of information may be input.

The in-loop filtering section 366 performs a filtering process as appropriate on the locally-decoded image in reference to the filter information Finfo.

For example, the in-loop filtering section 366 applies four in-loop filters, which are a bilateral filter, a deblocking filter (DBF (DeBlocking Filter)), an adaptive offset filter (SAO (Sample Adaptive Offset)), and an adaptive loop filter (ALF (Adaptive Loop Filter)), in this order. Note that filters to be applied can be any filters, and the order that the filters are applied can be any order. These can be selected as appropriate.

The in-loop filtering section 366 performs a filtering process corresponding to the filtering process performed by the coding side (e.g., the in-loop filtering section 170 of the coding section 113). Certainly, the filtering process to be performed by the in-loop filtering section 366 can be any filtering process, and is not limited to the example mentioned above. For example, the in-loop filtering section 366 may apply the Wiener filter or the like.

The in-loop filtering section 366 supplies the locally-decoded image having been subjected to the filtering process to the rearranging buffer 367 and the frame memory 368.

### <Rearranging Buffer>

The rearranging buffer 367 receives, as input, the locally-decoded image supplied from the in-loop filtering section 366, and retains (stores) it. The rearranging buffer 367 reconstructs the decoded image for each picture unit by using the locally-decoded image, and retains it (stores it in a buffer). The rearranging buffer 367 rearranges the obtained decoded images arranged in a decoding order such that the obtained decoded images are arranged in a reproduction order. The rearranging buffer 367 supplies the rearranged decoded image group to the crop processing section 313 as moving image data.

### <Frame Memory>

The frame memory 368 performs processes related to the storage of data related to an image. For example, the frame memory 368 receives, as input, the locally-decoded image supplied from the calculating section 365, reconstructs the decoded image for each picture unit, and stores it in a buffer in the frame memory 368.

In addition, the frame memory 368 receives, as input, the locally-decoded image that is supplied from the in-loop filtering section 366 and that has been subjected to the in-loop filtering process, reconstructs the decoded image for each picture unit, and stores it in a buffer in the frame memory 368. The frame memory 368 supplies the stored decoded images (or part thereof) to the predicting section 369 as reference images, as appropriate.

Note that the frame memory 368 may store the header information Hinfo, the prediction mode information Pinfo, the transformation information Tinfo, the filter information Finfo, and the like that are related to generation of decoded images.

### <Predicting Section>

The predicting section 369 performs processes related to generation of a prediction image. For example, the predicting section 369 receives, as input, the prediction mode information Pinfo supplied from the decoding section 362, performs prediction by a prediction method specified by the prediction mode information Pinfo, and derives the prediction image. When deriving the prediction image, the predicting section 369 uses, as a reference image, a decoded image (or part thereof) obtained before being subjected to filtering or after being subjected to filtering that is specified by the prediction mode information Pinfo and stored on the frame memory 218. The predicting section 369 supplies the derived prediction image to the calculating section 365.

By doing so, the decoding section 312 can inhibit a decrease of coding efficiency.

### <Procedure of Image Reception Process>

Next, an example of the procedure of an image reception process executed by the image receiving apparatus 300 is explained with reference to a flowchart in FIG. 21.

When the image reception process is started, in Step S301, the receiving section 311 of the image receiving apparatus 300 receives a bitstream supplied via a transfer path.

In Step S302, the decoding section 312 executes a decoding process, decodes the bitstream, and generates (restores) a transfer image.

In Step S303, the resolution control section 301 executes a resolution control process, and controls the resolution of a transfer-subject image.

In Step S304, according to the resolution control performed at the process in Step S303, the crop processing section 313 performs a crop process, and extracts a downsized image from the transfer image as necessary.

In Step S305, according to the resolution control performed at the process in Step S303, the resolution transforming section 314 performs a resolution transformation process, and, as necessary, performs upsampling of the downsized image extracted in Step S304, to generate (restore) a normal image.

In Step S306, the receiving section 311 determines whether or not to end the image reception process. In a case where the reception of the bitstream is not ended and the image reception process is determined not to be ended, the process returns to Step S301. Alternatively, in a case where it is determined in Step S306 that the reception of the bitstream is ended, the image reception process is ended.

### <Procedure of Decoding Process>

Next, an example of the procedure of the decoding process executed in Step S302 in FIG. 21 is explained with reference to a flowchart in FIG. 22.

When the decoding process is started, in Step S321, the accumulation buffer 361 acquires and retains (accumulates) the bitstream supplied from the receiving section 311.

In Step S322, the control section 351 acquires, from the bitstream, image frame information representing a transfer-subject image frame (resolution). For example, the control section 351 acquires downsized-image-frame information.

In Step S323, in reference to the downsized-image-frame information, the control section 351 determines whether or not the image frame (resolution) of the transfer-subject image switches. In a case where the image frame is determined to switch, the process proceeds to Step S324.

In Step S324, the control section 351 notifies the resolution control section 301 of the switching of the image frame. When the process in Step S324 is ended, the process proceeds to Step S325. In addition, in a case where it is determined in Step S323 that the image frame does not switch (the resolution of the transfer-subject image does not change), the process proceeds to Step S325.

In Step S325, the decoding section 362 extracts and decodes coded data from the bitstream, and obtains the quantization transformation coefficient level level. In addition, by this decoding, the decoding section 362 parses the bitstream to obtain various types of coding parameters (analyzes the bitstream to acquire the various types of coding parameters).

In Step S326, on the quantization transformation coefficient level level obtained by the process in Step S325, the inverse quantizing section 363 performs inverse quantization which is an inverse process of the quantization performed on the coding side, and obtains the transformation coefficient Coeff_IQ.

In Step S327, on the transformation coefficient Coeff_IQ obtained in Step S326, the inverse orthogonal transforming section 364 performs an inverse orthogonal transformation process which is an inverse process of the orthogonal transformation process performed on the coding side, and obtains a prediction residue D′.

In Step S328, in reference to the information obtained by the parsing in Step S325, the predicting section 369 executes a prediction process by a prediction method specified on the coding side, and generates a prediction image P by referring to the reference image stored on the frame memory 368, and so on.

In Step S329, the calculating section 365 adds together the prediction residue D′ obtained in Step S327 and the prediction image P obtained in Step S328, and derives a locally-decoded image Rlocal.

In Step S330, the in-loop filtering section 366 performs an in-loop filtering process on the locally-decoded image Rlocal obtained by the process in Step S329.

In Step S331, the rearranging buffer 367 derives the decoded image R by using the locally-decoded image Rlocal that has been subjected to the filtering process and that is obtained by the process in Step S330, and rearranges the decoded image R group arranged in a decoding order such that the decoded image R group is arranged in a reproduction order. The decoded image R group rearranged in the reproduction order is supplied to the crop processing section 313 as a moving image.

In addition, in Step S332, the frame memory 368 stores at least one of the locally-decoded image Rlocal obtained by the process in Step S329, and the locally-decoded image Rlocal that has been subjected to the filtering process and that is obtained by the process in Step S230.

When the process in Step S332 is ended, the decoding process is ended.

### <Procedure of Resolution Control Process>

Next, an example of the procedure of the resolution control process executed in Step S303 in FIG. 21 is explained with reference to a flowchart in FIG. 23.

When the resolution control process is started, in Step S351, the resolution control section 301 determines whether or not to change the resolution (image size) of the transfer-subject image from a normal setting (normal size) to a reduction setting (reduced size). In a case where the resolution is determined to be changed, the process proceeds to Step S352.

In Step S352, the resolution control section 301 controls the crop processing section 313 to start cropping of a downsized image from the transfer image.

In Step S353, the resolution control section 301 controls the resolution transforming section 314 to start resolution transformation (upsampling) from the reduced size to the normal size.

When Step S353 is ended, the resolution control process is ended, and the process returns to FIG. 21.

Alternatively, in a case where it is determined in Step S351 not to change the resolution from a normal setting to a reduction setting, the process proceeds to Step S354.

In Step S354, the resolution control section 301 determines whether or not to change the resolution (image size) of the transfer-subject image from a reduction setting (reduced size) to a normal setting (normal size). In a case where the resolution is determined to be changed, the process proceeds to Step S355.

In Step S355, the resolution control section 301 controls the crop processing section 313 to end cropping of a downsized image from the transfer image.

In Step S356, the resolution control section 301 controls the resolution transforming section 314 to end resolution transformation (upsampling) from the reduced size to the normal size.

When the process in Step S356 is ended, the resolution control process is ended, and the process returns to FIG. 21. In addition, in a case where it is determined in Step S354 not to change the resolution from a reduction setting to a normal setting, the resolution control process is ended, and the process returns to FIG. 21.

By executing the processes in the manner mentioned above, the image receiving apparatus 300 can control the resolution of a transfer-subject image without causing a discontinuity of the sequence; therefore, a decrease of coding efficiency can be inhibited.

### 5. Downsized-Image Transfer 2 With Normal Image Frame

### <Specification of Downsized-Image Area by Non-Skip Mode Area>

As written in the seventh row from top in the table in FIG. 6, blocks (CUs or macroblocks) at the boundary of a downsized-image area may be coded without fail in a mode (referred to as a non-skip mode) other than the skip mode, and a normal coding process may be performed on the downsized-image area inside the boundary (method 1-6). The area other than the downsized-image area is processed in the skip mode. In this case also, the image transmitting apparatus 100 can inhibit a decrease of coding efficiency as in the case of the first embodiment.

Then, as written in the eleventh row (bottom row) from top in the table in FIG. 6, on the receiving side, the skip mode/non-skip mode of each block may be traced, and the downsized-image area may be identified according to results thereof. In this case also, the image receiving apparatus 300 can inhibit a decrease of coding efficiency as in the case of the second embodiment.

For example, as depicted in FIG. 24, in a transfer image 401 including a downsized image, an area 411 including blocks of the boundary (periphery) of a downsized-image area 402 is coded in the non-skip mode, and the normal coding process is performed on an area 412 inside the boundary. By doing so, according to the shape of the area to which the non-skip mode is applied, the receiving side can identify the downsized-image area. That is, signaling of downsized-image-frame information can be omitted, and a decrease of coding efficiency can be inhibited. It should be noted that, in this case, the position and the size of the downsized-image area are represented in units of blocks (CUs or macroblocks).

### 6. Third Embodiment

### <Procedure of Downsized-Image Coding Process>

An example of the procedure of a downsized-image coding process in that case is explained with reference to flowcharts in FIG. 25 and FIG. 26.

When the downsized-image coding process is started, processes in Step S401 to Step S405 are executed similarly to the processes in Step S201 to Step S204 and Step S212 in FIG. 14. In addition, processes in Step S406 to Step S409 are executed similarly to the processes in Step S213 to Step S216 in FIG. 14.

In addition, in a case where it is determined in Step S404 that the processing-subject block is within a downsized-image area, the process proceeds to FIG. 26. In Step S421, the control section 151 determines whether or not the processing-subject block is a boundary block of the downsized-image area. In a case where it is determined that the processing-subject block is a boundary block, the process proceeds to Step S422.

In Step S422, the control section 151 prohibits the skip mode. The process proceeds to Step S423. Alternatively, in a case where it is determined in Step S421 that the processing-subject block is not a boundary block, the process proceeds to Step S423.

Processes in Step S423 to Step S429 are executed similarly to the processes in Step S205 to Step S211 in FIG. 14.

When the process in Step S429 is ended, the process returns to Step S406 in FIG. 25.

By doing so, the image transmitting apparatus 100 can inhibit a decrease of coding efficiency.

### 7. Fourth Embodiment

### <Procedure of Decoding Process>

An example of the procedure of a decoding process in that case is explained with reference to a flowchart in FIG. 27.

When the decoding process is started, a process in Step S501 is executed similarly to the process in Step S321 in FIG. 22.

In Step S502, the control section 351 performs an image-frame determination process.

Processes in Step S503 to Step S512 are executed similarly to the processes in Step S323 to Step S332 in FIG. 22.

### <Procedure of Image-Frame Determination Process>

An example of the procedure of the image-frame determination process executed in Step S502 in FIG. 27 is explained with reference to a flowchart in FIG. 28.

When the image-frame determination process is started, in Step S531, the control section 351 acquires skip mode information regarding each block.

In Step S532, the control section 351 determines whether there is a non-skip mode area outlined by a quadrangle. In a case where it is determined that there is a non-skip mode area, in Step S533, the control section 351 determines whether or not the quadrangular area is a normal image frame. In a case where it is determined that the quadrangular area is not a normal image frame, the control section 351 determines that the skip mode information is coded data of a downsized image in Step S534, derives downsized-image size information in Step S535, and derives downsized-image positional information in Step S536. The control section 351 supplies the resolution control section 301 with these pieces of information as downsized-image-frame information.

In addition, in a case where it is determined that there is not a non-skip mode area outlined by a quadrangle or that the quadrangular area is a normal image frame, in Step S537, the control section 351 determines that the skip mode information is coded data of a normal image.

By executing the processes in the manner mentioned above, the image receiving apparatus 300 can inhibit a decrease of coding efficiency.

### 8. Notes

### <Computer>

The series of processing mentioned above can be executed by hardware, and can also be executed by software. In a case where the series of processing is executed by software, a program included in the software is installed on a computer. Here, the computer may be a computer incorporated into dedicated hardware or, for example, a general-purpose personal computer or the like that can execute various types of functionalities by installing various types of programs.

FIG. 29 is a block diagram depicting an example of a configuration of hardware of a computer that executes the series of processing mentioned above, by using a program.

In a computer 800 depicted in FIG. 29, a CPU (Central Processing Unit) 801, a ROM (Read Only Memory) 802, and a RAM (Random Access Memory) 803 are interconnected via a bus 804.

The bus 804 is also connected with an input/output interface 810. The input/output interface 810 is connected with an input section 811, an output section 812, a storage section 813, a communication section 814, and a drive 815.

For example, the input section 811 includes a keyboard, a mouse, a microphone, a touch panel, an input terminal, and the like. For example, the output section 812 includes a display, speakers, an output terminal, and the like. For example, the storage section 813 includes a hard disk, a RAM disc, a nonvolatile memory, and the like. For example, the communication section 814 includes a network interface. The drive 815 drives a removable medium 821 such as a magnetic disc, an optical disc, a magneto-optical disc, or a semiconductor memory.

In the thus-configured computer, for example, the CPU 801 loads a program stored on the storage section 813 to the RAM 803 via the input/output interface 810 and the bus 804, and executes the program to thereby perform the series of processing mentioned above. As appropriate, the RAM 803 also has stored thereon data and the like necessary for the CPU 801 to execute various types of processes.

For example, the program executed by the computer can be applied by being recorded in the removable medium 821 as a package medium or the like. In that case, the program can be installed on the storage section 813 via the input/output interface 810 by attaching the removable medium 821 to the drive 815.

In addition, the program can also be provided via a cable transfer medium or a wireless transfer medium as exemplified by a local area network, the Internet, or digital satellite broadcasting. In that case, the program can be received at the communication section 814, and installed on the storage section 813.

Other than this, the program can also be installed in advance on the ROM 802 or the storage section 813.

### <Control Information>

Control information related to the present technology explained in each embodiment mentioned above may be transferred from the coding side to the decoding side. For example, control information (e.g., enabled_flag) for controlling whether or not to permit (or prohibit) application of the present technology mentioned above may be transferred. In addition, for example, control information (e.g., present_flag) representing a subject to which the present technology mentioned above is applied (or a subject to which the present technology is not applied) may be transferred. For example, control information specifying a frame, a component, or the like to which the present technology is applied (or specifying whether it is permitted or prohibited to apply the present technology to it) may be transferred.

### <Application Subjects of Present Technology>

The present technology can be applied to any image coding/decoding method.

In addition, the present technology can be applied to a multi-viewpoint image coding/decoding system that performs coding/decoding of multi-viewpoint images including images of multiple viewpoints (views (views)). In that case, it is sufficient if the present technology is applied to coding/decoding of each viewpoint (view (view)).

In addition, whereas the image transmitting apparatus 100 and the image receiving apparatus 300 are explained above as application examples of the present technology, the present technology can be applied to any type of configuration.

For example, the present technology can be applied to various types of electronic equipment such as a transmitter or a receiver (e.g., a television receiver or a mobile phone) in satellite broadcasting, cable broadcasting such as cable TV, distribution on the Internet, distribution to terminals in cellular communication, or the like; or an apparatus (e.g., a hard disk recorder or a camera) that records images on a medium such as an optical disc, a magnetic disc, or a flash memory or reproduces the images from those storage media.

In addition, for example, the present technology can also be implemented as a partial configuration of an apparatus, such as a processor (e.g., a video processor) as system LSI (Large Scale Integration) or the like; a module (e.g., a video module) that uses multiple processors or the like; a unit (e.g., a video unit) that uses multiple modules or the like; a set (e.g., a video set) which is a unit having still other additional functionalities; or the like.

In addition, for example, the present technology can also be applied to a network system including multiple apparatuses. For example, the present technology may be implemented as cloud computing in which multiple apparatuses perform processes in a sharing manner in cooperation with each other via a network. For example, the present technology may also be implemented in a cloud service of providing a service related to images (moving images) to any terminal such as a computer, AV (Audio Visual) equipment, a mobile information processing terminal, or an IoT (Internet of Things) device.

Note that, in the present specification, a system means a set of multiple constituent elements (apparatuses, modules (components), etc.), and it does not matter whether or not all the constituent elements are located in a single housing. Accordingly, multiple apparatuses housed in separate housings and connected via a network and one apparatus with one housing having housed therein multiple modules are both systems.

### <Fields/Uses to Which Present Technology Can Be Applied>

Systems, apparatuses, processing sections and the like to which the present technology is applied can be used in any field such as transportation, medical care, crime prevention, agriculture, the livestock industry, the mining industry, the beauty industry, factories, home electric appliances, meteorology, or nature monitoring, for example. In addition, its use in those fields also can be any use.

For example, the present technology can be applied to systems and devices prepared for providing content for appreciation, and the like. In addition, for example, the present technology can be applied also to systems and devices prepared for transportation such as supervision of traffic situations or automated driving control. Further, for example, the present technology can be applied also to systems and devices prepared for security. In addition, for example, the present technology can be applied to systems and devices that are prepared for automatic control of machines and the like. Further, for example, the present technology can be applied to systems and devices that are prepared for the agriculture and livestock industries. In addition, for example, the present technology can be applied also to systems and devices that monitor the states of nature, wildlife, and the like such as volcanos, forests, or oceans. Furthermore, for example, the present technology can be applied also to systems and devices prepared for sports.

### <Others>

Note that “flags” in the present specification are information for identifying multiple states, and include not only information used at a time when two states, which are true (1) and false (0), are identified, but also information that allows identification of three states or more. Accordingly, values that the “flags” can have may be two values, which are 1/0, for example, and may be three values or more. That is, the number of bits included in a “flag” can be any number, and the flags may be represented by one bit or may be represented by multiple bits. In addition, supposed forms of identification information (including flags also) include not only one in which identification information is included in a bitstream, but also one in which differential information of identification information relative to certain reference information is included in a bitstream. Accordingly, in the present specification, “flags” and “identification information” incorporate not only the information, but also differential information relative to reference information.

In addition, various types of information (metadata, etc.) related to coded data (bitstream) may be transferred or recorded in any form as long as the various types of information are associated with the coded data. Here, regarding the meaning of the term “associate,” when one piece of data and another piece of data are associated with each other, for example, the one piece of data becomes available at a time when the other piece of data is processed (the one piece of data can be linked with the other piece of data). That is, mutually associated pieces of data may be combined into one piece of data, or may be separate pieces of data. For example, information associated with coded data (image) may be transferred on a transfer path which is different from a transfer path on which the coded data (image) is transferred. In addition, for example, information associated with coded data (image) may be recorded on a recording medium different from a recording medium on which the coded data (image) is recorded (or in another recording area of the same recording medium on which the coded data (image) is recorded). Note that this “association” may be performed not on the entire data, but may be performed on part of the data. For example, an image and information corresponding to the image may be associated with each other in any units such as multiple frames, one frame, or part of a frame.

Note that, in the present specification, such terms as “synthesize,” “multiplex,” “add,” “integrate,” “include,” “store,” “push in,” “put in,” and “insert” mean that multiple objects are combined into one, as combining coded data and metadata into one piece of data, for example, and mean one method of “association” mentioned above.

In addition, embodiments of the present technology are not limited to the embodiments mentioned above, and can be modified in various manners within the scope not departing from the gist of the present technology.

For example, a constituent element explained as one apparatus (or processing section) may be divided, and configured as multiple apparatuses (or processing sections). Conversely, constituent elements explained as multiple apparatuses (or processing sections) above may be integrated, and configured as one apparatus (or processing section). In addition, constituent elements other than those mentioned above may certainly be added to the constituent elements of each apparatus (or each processing section). Further, as long as the configuration and operations as the whole system are substantially the same, some of the constituent elements of an apparatus (or processing section) may be included in the constituent elements of another apparatus (or another processing section).

In addition, for example, the program mentioned above may be executed in any apparatus. In that case, it is sufficient if the apparatus has necessary functionalities (functional blocks, etc.), and can obtain necessary information.

In addition, for example, each step in one flowchart may be executed by one apparatus or executed by multiple apparatuses in a sharing manner. Further, in a case where one step includes multiple processes, the multiple processes may be executed by one apparatus or executed by multiple apparatuses in a sharing manner. Stated differently, the multiple processes included in the one step can also be executed as processes of multiple steps. Conversely, processes explained as multiple steps can also be executed collectively as one step.

In addition, for example, regarding the program executed by the computer, processes of steps describing the program may be executed in a temporal sequence in line with an order explained in the present specification, may be executed in parallel, or may be executed individually at necessary timings such as timings when those processes are called. That is, as long as contradictions do not occur, processes of steps may be executed in an order different from the order mentioned above. Further, processes of steps describing the program may be executed in parallel with processes of other programs, and may be executed in combination with processes of other programs.

In addition, for example, multiple technologies related to the present technology can each be implemented independently and singly as long as such implementation does not give rise to contradictions. Certainly, any multiple aspects of the present technology can also be implemented in combination. For example, part or the whole of the present technology explained in any of the embodiments can also be implemented by being combined with part or the whole of the present technology explained in another embodiment. In addition, any part or the whole of the present technology mentioned above can also be implemented by being combined with another technology not mentioned above.

Note that the present technology can also have such a configuration as the ones below.

An image processing apparatus including:
a transfer image generating section that generates a transfer image that is a to-be-transferred image with a normal size including a downsized image obtained by size-reduction of a normal image whose image size is the normal size to a reduced size that is an image size smaller than the normal size; and
a coding section that codes the transfer image generated by the transfer image generating section.

The image processing apparatus according to (1), in which the transfer image generating section generates the transfer image by synthesizing the downsized image with the normal image obtained before the size-reduction.

The image processing apparatus according to (1), in which the coding section codes, in a skip mode, an area other than a downsized-image area that is a portion of the downsized image included in the transfer image.

The image processing apparatus according to (1), in which the coding section codes downsized-image-frame information representing a position and a size of the downsized image in the transfer image.

The image processing apparatus according to (1), in which the coding section prohibits application of a skip mode to a boundary block of a downsized-image area that is a portion of the downsized image included in the transfer image.

The image processing apparatus according to (1), further including:
a downsized-image generating section that generates the downsized image by size-reduction of the normal image, in which
the transfer image generating section generates the transfer image including the downsized image generated by the downsized-image generating section.

The image processing apparatus according to (1), further including:
a resolution control section that controls a resolution of an image to be transferred according to an execution transfer bandwidth, in which
the transfer image generating section
   generates the transfer image including the downsized image, in a case where the resolution control section performs control to transfer the downsized image, and
   sets the normal image as the transfer image, in a case where the resolution control section performs control to transfer the normal image, and
the coding section
   codes the transfer image that includes the downsized image and is generated by the transfer image generating section, in a case where the resolution control section performs control to transfer the downsized image, and
   codes the transfer image which is the normal image, in a case where the resolution control section performs control to transfer the normal image.

The image processing apparatus according to (7), in which, in a case where a resolution of an image to be transferred is changed by the resolution control section, the coding section performs the coding by setting a first picture obtained after the resolution change as a reference picture that is not an intra picture.

The image processing apparatus according to (7), in which, in a case where a resolution of an image to be transferred is changed by the resolution control section, the coding section performs the coding by setting a last picture obtained before the resolution change as a long term reference picture.

An image processing method including:
generating a transfer image that is a to-be-transferred image with a normal size including a downsized image obtained by size-reduction of a normal image whose image size is the normal size to a reduced size that is an image size smaller than the normal size; and
coding the generated transfer image.

(11) An image processing apparatus including:
a decoding section that decodes coded data, and generates a transfer image that is a to-be-transferred image with a normal size including a downsized image obtained by size-reduction of a normal image whose image size is the normal size to a reduced size that is an image size smaller than the normal size; and
a downsized-image extracting section that extracts the downsized image from the transfer image generated by the decoding section.

The image processing apparatus according to (11), further including:

a resolution transforming section that performs resolution transformation of the downsized image extracted by the downsized-image extracting section, and expands an image size of the downsized image to the normal size.

The image processing apparatus according to (11), in which
the decoding section decodes the coded data, and generates downsized-image-frame information representing a position and a size of the downsized image in the transfer image, and
the downsized-image extracting section extracts the downsized image from the transfer image in reference to the downsized-image-frame information.

The image processing apparatus according to (13), in which, in a case where there is the downsized-image-frame information corresponding to a processing-subject frame, the downsized-image extracting section extracts the downsized image from the transfer image.

The image processing apparatus according to (11), in which
the decoding section identifies a downsized-image area that is a portion of the downsized image included in the transfer image generated by decoding of the coded data, and
the downsized-image extracting section extracts the downsized image from the downsized-image area that is part of the transfer image and is identified by the decoding section.

The image processing apparatus according to (15), in which the decoding section identifies the downsized-image area according to a non-skip mode area that is included in the transfer image and is an area to which a non-skip mode is applied in coding.

The image processing apparatus according to (16), in which the decoding section identifies the downsized-image area according to a quadrangular area that is included in the transfer image and is outlined by the non-skip mode area.

The image processing apparatus according to (17), in which the decoding section
determines whether the transfer image includes the downsized image according to a size of the quadrangular area, and
identifies the downsized-image area in a case where it is determined that the downsized image is included.

The image processing apparatus according to (18), in which, in a case where the downsized-image area of the transfer image is identified by the decoding section, the downsized-image extracting section extracts the downsized image.

An image processing method including:
decoding coded data, and generating a transfer image that is a to-be-transferred image with a normal size including a downsized image obtained by size-reduction of a normal image whose image size is the normal size to a reduced size that is an image size smaller than the normal size; and
extracting the downsized image from the generated transfer image.

### REFERENCE SIGNS LIST

100: Image transmitting apparatus
101: Transfer method control section
111: Resolution transforming section
112: Video capture
113: Coding section
114: Transmitting section
300: Image receiving apparatus
301: Resolution control section
311: Receiving section
312: Decoding section
313: Crop processing section
314: Resolution transforming section

1. An image processing apparatus comprising:
a transfer image generating section that generates a transfer image that is a to-be-transferred image with a normal size including a downsized image obtained by size-reduction of a normal image whose image size is the normal size to a reduced size that is an image size smaller than the normal size; and
a coding section that codes the transfer image generated by the transfer image generating section.

2. The image processing apparatus according to claim 1, wherein the transfer image generating section generates the transfer image by synthesizing the downsized image with the normal image obtained before the size-reduction.

3. The image processing apparatus according to claim 1, wherein the coding section codes, in a skip mode, an area other than a downsized-image area that is a portion of the downsized image included in the transfer image.

4. The image processing apparatus according to claim 1, wherein the coding section codes downsized-image-frame information representing a position and a size of the downsized image in the transfer image.

5. The image processing apparatus according to claim 1, wherein the coding section prohibits application of a skip mode to a boundary block of a downsized-image area that is a portion of the downsized image included in the transfer image.

6. The image processing apparatus according to claim 1, further comprising:
a downsized-image generating section that generates the downsized image by size-reduction of the normal image, wherein
the transfer image generating section generates the transfer image including the downsized image generated by the downsized-image generating section.

7. The image processing apparatus according to claim 1, further comprising:
a resolution control section that controls a resolution of an image to be transferred according to an execution transfer bandwidth, wherein
the transfer image generating section
generates the transfer image including the downsized image, in a case where the resolution control section performs control to transfer the downsized image, and
sets the normal image as the transfer image, in a case where the resolution control section performs control to transfer the normal image, and
the coding section
codes the transfer image that includes the downsized image and is generated by the transfer image generating section, in a case where the resolution control section performs control to transfer the downsized image, and
codes the transfer image which is the normal image, in a case where the resolution control section performs control to transfer the normal image.

8. The image processing apparatus according to claim 7, wherein, in a case where a resolution of an image to be transferred is changed by the resolution control section, the coding section performs the coding by setting a first picture obtained after the resolution change as a reference picture that is not an intra picture.

9. The image processing apparatus according to claim 7, wherein, in a case where a resolution of an image to be transferred is changed by the resolution control section, the coding section performs the coding by setting a last picture obtained before the resolution change as a long term reference picture.

10. An image processing method comprising:
generating a transfer image that is a to-be-transferred image with a normal size including a downsized image obtained by size-reduction of a normal image whose image size is the normal size to a reduced size that is an image size smaller than the normal size; and
coding the generated transfer image.

11. An image processing apparatus comprising:
a decoding section that decodes coded data, and generates a transfer image that is a to-be-transferred image with a normal size including a downsized image obtained by size-reduction of a normal image whose image size is the normal size to a reduced size that is an image size smaller than the normal size; and
a downsized-image extracting section that extracts the downsized image from the transfer image generated by the decoding section.

12. The image processing apparatus according to claim 11, further comprising:
a resolution transforming section that performs resolution transformation of the downsized image extracted by the downsized-image extracting section, and expands an image size of the downsized image to the normal size.

13. The image processing apparatus according to claim 11, wherein
the decoding section decodes the coded data, and generates downsized-image-frame information representing a position and a size of the downsized image in the transfer image, and
the downsized-image extracting section extracts the downsized image from the transfer image in reference to the downsized-image-frame information.

14. The image processing apparatus according to claim 13, wherein, in a case where there is the downsized-image-frame information corresponding to a processing-subject frame, the downsized-image extracting section extracts the downsized image from the transfer image.

15. The image processing apparatus according to claim 11, wherein
the decoding section identifies a downsized-image area that is a portion of the downsized image included in the transfer image generated by decoding of the coded data, and
the downsized-image extracting section extracts the downsized image from the downsized-image area that is part of the transfer image and is identified by the decoding section.

16. The image processing apparatus according to claim 15, wherein the decoding section identifies the downsized-image area according to a non-skip mode area that is included in the transfer image and is an area to which a non-skip mode is applied in coding.

17. The image processing apparatus according to claim 16, wherein the decoding section identifies the downsized-image area according to a quadrangular area that is included in the transfer image and is outlined by the non-skip mode area.

18. The image processing apparatus according to claim 17, wherein
the decoding section
determines whether the transfer image includes the downsized image according to a size of the quadrangular area, and
identifies the downsized-image area in a case where it is determined that the downsized image is included.

19. The image processing apparatus according to claim 18, wherein, in a case where the downsized-image area of the transfer image is identified by the decoding section, the downsized-image extracting section extracts the downsized image.

20. An image processing method comprising:
decoding coded data, and generating a transfer image that is a to-be-transferred image with a normal size including a downsized image obtained by size-reduction of a normal image whose image size is the normal size to a reduced size that is an image size smaller than the normal size; and
extracting the downsized image from the generated transfer image.
